(19) United States
(12) Patent Application Publication
(10) Pub. No.: US 2025/0021662 A1
(43) Pub. Date: Jan. 16, 2025

(54) ANALYZING SOFTWARE BUILD CHANGES BASED ON SOFTWARE VULNERABILITIES

(71) Applicant: Aurora Labs Ltd., Tel Aviv (IL)

(72) Inventors: Jonathan Katz, Lod (IL); Tal Avidan, Ramat Gan (IL)

(73) Assignee: Aurora Labs Ltd., Tel Aviv (IL)

(21) Appl. No.: 18/765,734

(22) Filed: Jul. 8, 2024

Related U.S. Application Data
(60) Provisional application No. 63/512,788, filed on Jul. 10, 2023.

(51) Int. Cl. G06F 21/57; G06F 8/71

(52) U.S. Cl. CPC G06F 21/577; G06F 8/71

(57) ABSTRACT

Disclosed herein are techniques for analyzing software build changes. Techniques include accessing first executable code associated with a first version; accessing second executable code associated with a second version; determining a code delta between the first executable code and the second executable code, the code delta being based on a change of at least one first element of code in the first executable code to at least one second element of code in the second executable code; determining a software vulnerability associated with at least one of the at least one first element of code or the at least one second element of code; and generating a report including a pairing of an indicator of the software vulnerability with an indicator of at least one of the at least one first element of code or the at least one second element of code.

### CROSS-REFERENCE TO RELATED APPLICATIONS

This application claims priority to U.S. Provisional Patent App. No. 63/512,788, filed on Jul. 10, 2023, which is incorporated herein by reference in its entirety.

### TECHNICAL FIELD

The subject matter described herein generally relates to techniques for improving efficiencies in coding environments, including environments associated with code testing, linker script file generation, AI data prediction, vulnerability assessment, and file optimization. Such techniques may be applied to vehicle software and systems, as well as to various other types of Internet-of-Things (IoT) or network-connected systems that utilize controllers such as electronic control units (ECUs) or other controllers or devices. For example, certain disclosed embodiments are directed to analyzing programming code and code test configurations to reduce test execution time and strain on digital processing resources. Some disclosed embodiments are directed to generating linker script files using different data types. Disclosed embodiments also include AI-based data size prediction. Additional embodiments involve build change detection and utilization for vulnerability detection. Further embodiments are directed to security patch optimization.

### BACKGROUND

Modern computing devices and systems, including personal computing devices and Internet of Things (IoT) systems, often operate using complicated and lengthy software instructions. Moreover, in many environments, digital information (such as code or data associated with a program) is bloated, dispersed, ill-formatted, or redundant, which leads to increased strain on computing environment resources, such as memory resources, processing resources, communication resources, and network resources.

In view of the technical deficiencies of current systems, there is a need for improved systems and methods for reducing processing loads for software testing. The techniques discussed below offer many technological improvements in performance of testing programming code. For example, structure and functionality of programming code may be analyzed in conjunction with tests intended for the programming code, and a test execution order may be established to reduce execution time associated with applying the tests to the programming code.

Related advantages may result from disclosed techniques involving generating linker script files. For example, programming data existing in multiple formats may be connected and analyzed to generate a properly structured linker script file usable to generate a correct executable file, while also reducing errors in generating the linker script file. These flexible techniques may generate properly structured linker script files regardless of a platform or compiler used for the underlying programming data, and without a need to access the platform or compiler.

As yet another advantage, disclosed techniques include training and using artificial intelligence (AI) models to predict data size. Some embodiments may allow for predicting memory space allocation data sizes for a body of programming code. By training and using an AI model to accurately predict allocation space based on code parameters, data, and metadata, an amount of memory space may be allocated that is neither overly large (thus preventing the use of memory space for other purposes) nor overly small (thus preventing use of the body of programming code).

Disclosed embodiments also relate to automatically detecting and analyzing build changes across computer programs. For example, some embodiments may involve determining deltas between versions of programming code and using the deltas to determine applicability of vulnerabilities to a version of programming code. Such techniques can reduce a number of patches or fixes needed, and can also be used to accurately track versions of programming code to detect errors or vulnerabilities associated with a particular delta.

Other advantages in the disclosed embodiments are associated with optimizing security patches. For example, in some embodiments, programming code may be analyzed to detect local fixes or unused code that would otherwise be associated with a particular patch by a security scanner and reduce the size of a security patch by removing unnecessary or redundant code. This results in a smaller security patch that requires less memory space for storage, and is quicker to transmit and/or execute, reducing strain on computing resources and freeing them for other uses.

### SUMMARY

Some disclosed embodiments describe non-transitory computer-readable media, systems, and methods for improving efficiencies associated with programming code to reduce strain on computing resources. For example, in an exemplary embodiment, a non-transitory computer-readable medium may include instructions that, when executed by at least one processor, cause the at least one processor to perform operations for reducing processing load for software testing. The operations may comprise accessing code for testing; performing functional analysis of the code to construct a functional behavior representation of the code; determining, based on the functional behavior representation, a first testing interaction between a first test and the code; determining, based on the functional behavior representation, a second testing interaction between a second test and the code; determining that the first testing interaction is stronger than the second testing interaction; and based on the determination that the first testing interaction is stronger than the second testing interaction, applying the first test to the code.

In accordance with further embodiments, performing the functional analysis of the code comprises applying at least one of static or dynamic analysis to the code, and the static or dynamic analysis identifies at least one of a number of calls performed; a processor-off or processor-on metric; an amount of memory used; a symbol represented by the code or a relationship between a plurality of symbols; or hardware-sourced data correlated with the code.

In accordance with further embodiments, the static or dynamic analysis identifies the hardware-sourced data, the hardware-sourced data being correlated with at least one time of execution of at least one function associated with the code.

In accordance with further embodiments, the hardware-sourced data comprises at least one of: a sensor value, a voltage value, or a temperature value.

In accordance with further embodiments, at least one of the symbols is a function, a variable, a buffer, a call, an object, or a segment of code.

In accordance with further embodiments, the functional behavior representation of the code includes symbols represented by the code and relationships between the symbols.

In accordance with further embodiments, the symbols include functions; and the functional behavior representation of the code includes a number of calls between the functions.

In accordance with further embodiments, the first testing interaction and the second testing interaction are determined based on an identification of a change to a function represented in the code.

In accordance with further embodiments, the first testing interaction and the second testing interaction are determined based on a relationship between the changed function and at least one other function.

In accordance with further embodiments, determining the first testing interaction and the second testing interaction includes scoring the first test and the second test based on: a first set of interactions between the first test and both the changed function and the at least one other function; and a second set of interactions between the second test and both the changed function and the at least one other function.

In accordance with further embodiments, the accessed code is a first version of the code including at least one function changed relative to a second version of the code. The operations may also further comprise applying the first test to the second version of the code to determine initial first test behavior and applying the second test to the second version of the code to determine initial second test behavior. The first testing interaction may be based on the initial first test behavior and the second testing interaction may be based on the initial second test behavior.

In accordance with further embodiments, the operations further comprise recalibrating the initial first test behavior based on the determined first test interaction and recalibrating the initial second test behavior based on the determined second test interaction.

In accordance with further embodiments, the code for testing is configured for execution on a controller.

In accordance with further embodiments, at least one of the first test or the second test is an integration test, a production test, a system test, or a unit test.

Further disclosed embodiments include a method for reducing processing load for software testing. The method may comprise accessing code for testing; performing functional analysis of the code to construct a functional behavior representation of the code; determining, based on the functional behavior representation, a first testing interaction between a first test and the code; determining, based on the functional behavior representation, a second testing interaction between a second test and the code; determining that the first testing interaction is stronger than the second testing interaction; and based on the determination that the first testing interaction is stronger than the second testing interaction, applying the first test to the code.

In accordance with further embodiments, performing the functional analysis of the code comprises applying at least one of static or dynamic analysis to the code, and the static or dynamic analysis identifies at least one of a number of calls performed; a processor-off or processor-on metric; an amount of memory used; a symbol represented by the code or a relationship between a plurality of symbols; or hardware-sourced data correlated with the code.

In accordance with further embodiments, the static or dynamic analysis identifies the hardware-sourced data, the hardware-sourced data being correlated with at least one time of execution of at least one function associated with the code.

In accordance with further embodiments, the hardware-sourced data comprises at least one of: a sensor value, a voltage value, or a temperature value.

In accordance with further embodiments, at least one of the symbols is a function, a variable, a buffer, a call, an object, or a segment of code.

In accordance with further embodiments, the functional behavior representation of the code includes symbols represented by the code and relationships between the symbols.

In accordance with further embodiments, the symbols include functions; and the functional behavior representation of the code includes a number of calls between the functions.

In accordance with further embodiments, the first testing interaction and the second testing interaction are determined based on an identification of a change to a function represented in the code.

In accordance with further embodiments, the first testing interaction and the second testing interaction are determined based on a relationship between the changed function and at least one other function.

In accordance with further embodiments, determining the first testing interaction and the second testing interaction includes scoring the first test and the second test based on: a first set of interactions between the first test and both the changed function and the at least one other function; and a second set of interactions between the second test and both the changed function and the at least one other function.

In accordance with further embodiments, the accessed code is a first version of the code including at least one function changed relative to a second version of the code. The computer-implemented method may also further comprise applying the first test to the second version of the code to determine initial first test behavior and applying the second test to the second version of the code to determine initial second test behavior. The first testing interaction may be based on the initial first test behavior and the second testing interaction may be based on the initial second test behavior.

In accordance with further embodiments, the computer-implemented method further comprises recalibrating the initial first test behavior based on the determined first test interaction and recalibrating the initial second test behavior based on the determined second test interaction.

In accordance with further embodiments, the code for testing is configured for execution on a controller.

In accordance with further embodiments, at least one of the first test or the second test is an integration test, a production test, a system test, or a unit test.

In another exemplary embodiment, a non-transitory computer-readable medium may include instructions that, when executed by at least one processor, cause the at least one processor to perform operations for generating a linker script file. The operations may comprise accessing user definition code; accessing user configuration code; based on the user definition code and the user configuration code, identifying at least one linker script syntax; and generating a linker script file configured for generating executable code, the linker script file being based on the user definition code and the user configuration code.

In accordance with further embodiments, the linker script file indicates at least one of: a memory layout, a relationship between executable code and data, or a memory write location associated with the executable code.

In accordance with further embodiments, at least one of the user definition code or the user configuration code is associated with at least one of differing communication protocols, differing operating systems, differing middleware, differing application software, or differing development environments.

In accordance with further embodiments, generating the linker script file comprises determining interdependent portions of code associated with at least one of the user definition code or the user configuration code.

In accordance with further embodiments, the operations further comprise generating the executable code based on the linker script file.

In accordance with further embodiments, the user definition code comprises at least one of a comma-separated values (CSV) file, a text file, an Extensive Markup Language (XML) file, or a table.

In accordance with further embodiments, the user definition code indicates at least one of: a memory region name, a memory address, a symbol type, or a symbol name.

Further disclosed embodiments include a method for generating a linker script file. The method may comprise accessing user definition code; accessing user configuration code; based on the user definition code and the user configuration code, identifying at least one linker script syntax; and generating a linker script file configured for generating executable code, the linker script file being based on the user definition code and the user configuration code.

In accordance with further embodiments, the linker script file indicates at least one of: a memory layout, a relationship between executable code and data, or a memory write location associated with the executable code.

In accordance with further embodiments, at least one of the user definition code or the user configuration code is associated with at least one of differing communication protocols, differing operating systems, differing middleware, differing application software, or differing development environments.

In accordance with further embodiments, generating the linker script file comprises determining interdependent portions of code associated with at least one of the user definition code or the user configuration code.

In accordance with further embodiments, the method further comprises generating the executable code based on the linker script file.

In accordance with further embodiments, the user definition code comprises at least one of a comma-separated values (CSV) file, a text file, an Extensive Markup Language (XML) file, or a table.

In accordance with further embodiments, the user definition code indicates at least one of: a memory region name, a memory address, a symbol type, or a symbol name.

In another exemplary embodiment, a non-transitory computer-readable medium may include instructions that, when executed by at least one processor, cause the at least one processor to perform operations for training a model to predict data size. The operations may comprise initializing a model having model parameters; training the model to predict source code data size by: inputting first model input data to the model, the first model input data including a first set of source code parameters associated with a data size parameter associated with a first source code, and modifying at least one of the model parameters to improve prediction of source code data size by the model; and validating the model by inputting second model input data to the trained model, the second model input data including a second set of source code parameters associated with a data size parameter of a second source code.

In accordance with further embodiments, the operations further comprise applying the validated model to third model input data to predict a data size parameter of a third source code and automatically allocating memory space based on the predicted data size parameter of the third source code.

In accordance with further embodiments, the data size parameter associated with the first source code comprises a size of an address table.

In accordance with further embodiments, the address table is sized to accommodate the first source code.

In accordance with further embodiments, the address table is associated with a differential update file generated based on a multidimensional software comparison.

In accordance with further embodiments, the data size parameter associated with the first source code comprises a scratchpad size.

In accordance with further embodiments, the data size parameter associated with the first source code comprises a patch size.

In accordance with further embodiments, the data size parameter associated with the first source code comprises a keep section.

In accordance with further embodiments, the first set of source code parameters comprises at least one of: a version identifier associated with the first source code, a number of symbols associated with the first source code, a starting date associated with the first source code, a current date, or a time since a starting date associated with the first source code.

In accordance with further embodiments, the first set of source code parameters comprises a flash memory size associated with the first source code.

In accordance with further embodiments, the first set of source code parameters comprises a random access memory (RAM) size associated with the first source code.

In accordance with further embodiments, the model is trained to correlate a larger number of symbols with a larger source code data size or correlate a longer amount of time since a starting date associated with the first source code with a larger source code data size.

Further disclosed embodiments include a method for training a model to predict data size. The method may comprise initializing a model having model parameters; training the model to predict source code data size by: inputting first model input data to the model, the first model input data including a first set of source code parameters associated with a data size parameter associated with a first source code, and modifying at least one of the model parameters to improve prediction of source code data size by the model; and validating the model by inputting second model input data to the trained model, the second model input data including a second set of source code parameters associated with a data size parameter of a second source code.

In accordance with further embodiments, the method further comprises applying the validated model to third model input data to predict a data size parameter of a third source code and automatically allocating memory space based on the predicted data size parameter of the third source code.

In accordance with further embodiments, the data size parameter associated with the first source code comprises a size of an address table.

In accordance with further embodiments, the address table is sized to accommodate the first source code.

In accordance with further embodiments, the address table is associated with a differential update file generated based on a multidimensional software comparison.

In accordance with further embodiments, the data size parameter associated with the first source code comprises a scratchpad size.

In accordance with further embodiments, the data size parameter associated with the first source code comprises a patch size.

In accordance with further embodiments, the data size parameter associated with the first source code comprises a keep section.

In accordance with further embodiments, the first set of source code parameters comprises at least one of: a version identifier associated with the first source code, a number of symbols associated with the first source code, a starting date associated with the first source code, a current date, or a time since a starting date associated with the first source code.

In accordance with further embodiments, the first set of source code parameters comprises a flash memory size associated with the first source code.

In accordance with further embodiments, the first set of source code parameters comprises a random access memory (RAM) size associated with the first source code.

In accordance with further embodiments, the model is trained to correlate a larger number of symbols with a larger source code data size or correlate a longer amount of time since a starting date associated with the first source code with a larger source code data size.

In another exemplary embodiment, a non-transitory computer-readable medium may include instructions that, when executed by at least one processor, cause the at least one processor to perform operations for analyzing software build changes. The operations may comprise accessing first executable code associated with a first version; accessing second executable code associated with a second version; determining a code delta between the first executable code and the second executable code, the code delta being based on a change of at least one first element of code in the first executable code to at least one second element of code in the second executable code; determining a software vulnerability associated with at least one of the at least one first element of code or the at least one second element of code; and generating a report including a pairing of an indicator of the software vulnerability with an indicator of at least one of the at least one first element of code or the at least one second element of code.

In accordance with further embodiments, the paired indicator of the software vulnerability with the indicator of at least one of the at least one first element of code or the at least one second element of code are associated with a time and a software developer associated with introducing the software vulnerability.

In accordance with further embodiments, the report includes multiple pairings of software vulnerability indicators with element-of-code changes between the first executable code and the second executable code.

In accordance with further embodiments, the pairings are associated with multiple descriptor parameters.

In accordance with further embodiments, the report is filterable by at least one of the descriptor parameters.

In accordance with further embodiments, the report is orderable by at least one of the descriptor parameters.

In accordance with further embodiments, the descriptor parameters include at least one of a file name, a build identifier, a version identifier, a commit identifier, a developer name, a date, a time, a symbol identifier, or a 3rd-party package identifier.

In accordance with further embodiments, determining a code delta between the first executable code and the second executable code comprises determining at least one of a symbol or a 3rd-party package added or removed in the second executable code relative to the first executable code; and the report includes an indication of the at least one of a symbol or a 3rd-party package added or removed.

In accordance with further embodiments, determining a software vulnerability associated with at least one of the at least one first element of code or the at least one second element of code comprises determining a symbol associated with at least one of the at least one first element of code or the at least one second element of code; and the indicator included in the report includes the determined symbol.

Further disclosed embodiments include a method for analyzing software build changes. The method may comprise accessing first executable code associated with a first version; accessing second executable code associated with a second version; determining a code delta between the first executable code and the second executable code, the code delta being based on a change of at least one first element of code in the first executable code to at least one second element of code in the second executable code; determining a software vulnerability associated with at least one of the at least one first element of code or the at least one second element of code; and generating a report including a pairing of an indicator of the software vulnerability with an indicator of at least one of the at least one first element of code or the at least one second element of code.

In accordance with further embodiments, the paired indicator of the software vulnerability with the indicator of at least one of the at least one first element of code or the at least one second element of code are associated with a time and a software developer associated with introducing the software vulnerability.

In accordance with further embodiments, the report includes multiple pairings of software vulnerability indicators with element-of-code changes between the first executable code and the second executable code.

In accordance with further embodiments, the pairings are associated with multiple descriptor parameters.

In accordance with further embodiments, the report is filterable by at least one of the descriptor parameters.

In accordance with further embodiments, the report is orderable by at least one of the descriptor parameters.

In accordance with further embodiments, the descriptor parameters include at least one of a file name, a build identifier, a version identifier, a commit identifier, a developer name, a date, a time, a symbol identifier, or a 3rd-party package identifier.

In accordance with further embodiments, determining a code delta between the first executable code and the second executable code comprises determining at least one of a symbol or a 3rd-party package added or removed in the second executable code relative to the first executable code; and the report includes an indication of the at least one of a symbol or a 3rd-party package added or removed.

In accordance with further embodiments, determining a software vulnerability associated with at least one of the at least one first element of code or the at least one second element of code comprises determining a symbol associated with at least one of the at least one first element of code or the at least one second element of code; and the indicator included in the report includes the determined symbol.

In another exemplary embodiment, a non-transitory computer-readable medium may include instructions that, when executed by at least one processor, cause the at least one processor to perform operations for shrinking security patches. The operations may comprise accessing executable code; scanning the executable code for an indicator of 3rd-party code associated with a software vulnerability; identifying, based on the scanning, the indicator of 3rd-party code; determining, based on the scanning, that the executable code includes a local fix patching the software vulnerability or that the executable code is not configured to rely on the 3rd-party code; and based on the determination that the executable code includes a local fix patching the software vulnerability or that the executable code is not configured to rely on the 3rd-party code, performing at least one of: generating a security patch file that does not patch the software vulnerability; or removing, from a security patch file, a patch associated with the software vulnerability, thereby reducing a size of the security patch file.

In accordance with further embodiments, the operations further comprise including, in a report, an indication of the determination that the executable code includes a local fix patching the software vulnerability or that the executable code is not configured to rely on the 3rd-party code.

In accordance with further embodiments, the indicator of 3rd-party code includes a version identifier of the 3rd-party code.

In accordance with further embodiments, the operations further comprise determining, based on the scanning, that the executable code is not configured to rely on the 3rd-party code by determining that the executable code does not include a call to the 3rd-party code.

In accordance with further embodiments, the executable code is configured to execute on a controller.

In accordance with further embodiments, the 3rd-party code is a 3rd-party software package.

Further disclosed embodiments include a method for shrinking security patches. The method may comprise accessing executable code; scanning the executable code for an indicator of 3rd-party code associated with a software vulnerability; identifying, based on the scanning, the indicator of 3rd-party code; determining, based on the scanning, that the executable code includes a local fix patching the software vulnerability or that the executable code is not configured to rely on the 3rd-party code; and based on the determination that the executable code includes a local fix patching the software vulnerability or that the executable code is not configured to rely on the 3rd-party code, performing at least one of: generating a security patch file that does not patch the software vulnerability; or removing, from a security patch file, a patch associated with the software vulnerability, thereby reducing a size of the security patch file.

In accordance with further embodiments, the method further comprises including, in a report, an indication of the determination that the executable code includes a local fix patching the software vulnerability or that the executable code is not configured to rely on the 3rd-party code.

In accordance with further embodiments, the indicator of 3rd-party code includes a version identifier of the 3rd-party code.

In accordance with further embodiments, the method further comprises determining, based on the scanning, that the executable code is not configured to rely on the 3rd-party code by determining that the executable code does not include a call to the 3rd-party code.

In accordance with further embodiments, the executable code is configured to execute on a controller.

In accordance with further embodiments, the 3rd-party code is a 3rd-party software package.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performable and/or performed by one or more processors, which may be part of a device or system and/or configured (e.g., as special-purpose processor(s)), based on software instructions that are programmed with logic and instructions that perform, when executed, one or more operations consistent with the disclosed embodiments. Moreover, aspects of the disclosed embodiments may be performed as part of a method. For example, an operation performable by a processor according to an executable instruction stored in include a tangible computer-readable medium may be included as a step within a method.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an exemplary pictographic representation of a network architecture for providing analysis and modeling benefits to devices, consistent with embodiments of the present disclosure.

FIG. 2 illustrates an exemplary pictographic representation of a modeler system, consistent with embodiments of the present disclosure.

FIG. 3 illustrates an exemplary pictographic representation of a code interpretation environment, consistent with embodiments of the present disclosure.

FIG. 4 illustrates an exemplary pictographic representation of a layered model architecture, consistent with embodiments of the present disclosure.

FIG. 5 depicts a flowchart of an exemplary process for reducing processing load for software testing, consistent with embodiments of the present disclosure.

FIG. 6 depicts a visualization of function relationships and programming code test selection, consistent with embodiments of the present disclosure.

FIG. 7 depicts a flowchart of an exemplary process for generating a linker script file, consistent with embodiments of the present disclosure.

FIG. 8 depicts a visualization of a linker file configuration, consistent with embodiments of the present disclosure.

FIG. 9 depicts a flowchart of an exemplary process for training a model to predict data size, consistent with embodiments of the present disclosure.

FIG. 10 depicts a flowchart of an exemplary process for analyzing software build changes, consistent with embodiments of the present disclosure.

FIG. 11 depicts a flowchart of an exemplary process for shrinking security patches, consistent with embodiments of the present disclosure.

### DETAILED DESCRIPTION OF EXEMPLARY EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

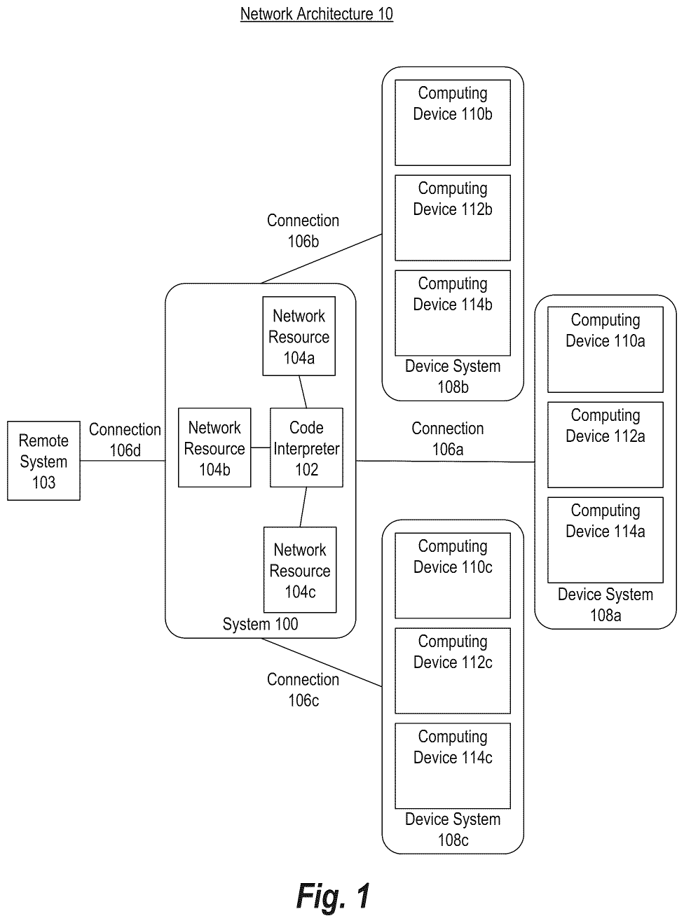

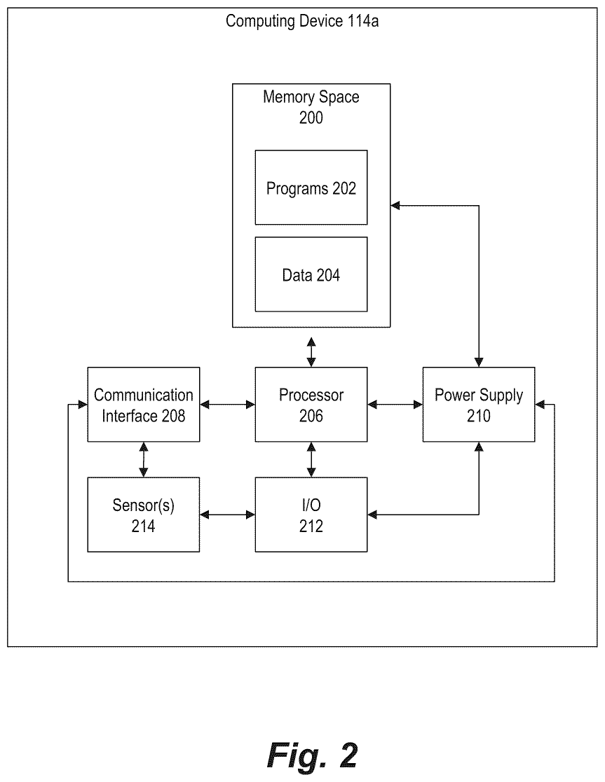

FIG. 1 illustrates an exemplary pictographic representation of network architecture 10, which may include a system 100. System 100 may be maintained, for example, by an artificial intelligence (AI) analysis provider, a security provider, software developer, an entity associated with developing or improving computer software, or any combination of these entities. System 100 may include a code interpreter 102, which may be a single device or combination of devices, and is described in further detail with respect to FIG. 2. Code interpreter 102 may be in communication with any number of network resources, such as network resources 104a, 104b, and/or 104c. A network resource may be a database, supercomputer, general purpose computer, special purpose computer, virtual computing resource (e.g., a virtual machine or a container), graphics processing unit (GPU), or any other data storage or processing resource.

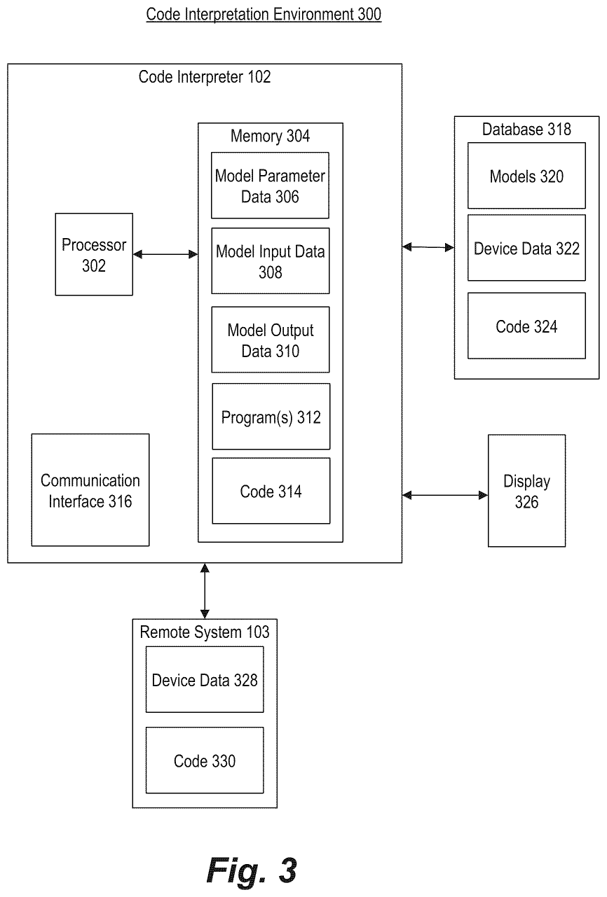

Network architecture 10 may also include any number of device systems, such as device systems 108a, 108b, and 108c. A device system may be, for example, a computer system, a home security system, a parking garage sensor system, a vehicle, an inventory monitoring system, a connected appliance, telephony equipment, a network routing device, a smart power grid system, a drone or other unmanned vehicle, a hospital monitoring system, any Internet of Things (IoT) system, or any arrangement of one or more computing devices. A device system may include devices arranged in a local area network (LAN), a wide area network (WAN), or any other communications network arrangement. Further, each controller system may include any number of devices, such as controllers. For example, exemplary device system 108a includes computing devices 110a, 112a, and 114a, which may have the same or different functionalities or purposes. These devices are discussed further through the description of exemplary computing device 114a, discussed with respect to FIG. 3. Device systems 108a, 108b, and 108c may connect to system 100 through connections 106a, 106b, and 106c, respectively. System 100 may also connect through connection 106d to a remote system 103, which may include any number of computing devices (e.g., one or more servers, personal desktop computers, computing machines, etc.). Remote system 103 may be associated with a creator of code, a manufacturer of a physical component and/or device (e.g., controller), a system (e.g., vehicle) manufacturer, or another entity associated with developing and/or deploying software. In some embodiments, remote system 103 may also connect to a device system (e.g., device system 108a), such as through a connection separate from connection 106d. In some embodiments, a device system (e.g., device system 108a) may have a connection with remote system 103, but may have no direct connection to system 100. For example, a device system may connect to remote system 103, which may then in turn connect to system 100. In some embodiments, system 100 may provide digital information to remote system 103 based on operations performed by system 100 (e.g., as discussed with respect to the figures below). A connection 106 (exemplified by connections 106a, 106b, 106c, and 106d) may be a communication channel, which may include a bus, a cable, a wireless (e.g., over-the-air) communication channel, a radio-based communication channel, a local area network (LAN), the Internet, a wireless local area network (WLAN), a wide area network (WAN), a cellular communication network, or any Internet Protocol (IP) based communication network and the like. Connections 106a, 106b, 106c, and 106d may be of the same type or of different types, and may include combinations of types (e.g., the Internet and a LAN).

Any combination of components of network architecture 10 may perform any number of steps of the exemplary processes discussed herein, consistent with the disclosed exemplary embodiments.

FIG. 2 illustrates an exemplary pictographic representation of computing device 114a, which may be a computer, a server, an IoT device, or a controller. For example, computing device 114a may be an automotive controller, such as an electronic control unit (ECU) (e.g., manufactured by companies such as Bosch™ Delphi Electronics™, Continental™, Denso™, etc.), or may be a non-automotive controller, such as an IoT controller manufactured by Skyworks™, Qorvo™, Qualcomm™, NXP Semiconductors™, etc. Computing device 114a may be configured (e.g., through programs 202) to perform a single function (e.g., a braking function in a vehicle), or multiple functions. Computing device 114a may perform any number of steps of the exemplary processes discussed herein, consistent with the disclosed exemplary embodiments.

Computing device 114a may include a memory space 200 and a processor 206. Memory space 200 may include a single memory component, or multiple memory components. Such memory components may include an electronic storage device, a magnetic storage device, an optical storage device, an electromagnetic storage device, a semiconductor storage device, or any suitable combination of the foregoing. For example, memory space 200 may include any number of hard disks, random access memories (RAMs), read-only memories (ROMs), erasable programmable read-only memories (EPROMs or Flash memories), and the like. Memory space 200 may include one or more storage devices configured to store instructions usable by processor 206 to perform functions related to the disclosed embodiments. For example, memory space 200 may be configured with one or more software instructions, such as software program(s) 202 or code segments that perform one or more operations when executed by processor 206 (e.g., the operations discussed in connection with figures below). The disclosed embodiments are not limited to separate programs or computers configured to perform dedicated tasks. For example, memory space 200 may include a single program or multiple programs that perform the functions associated with network architecture 10. In some embodiments, memory space 200 may include data 204, such as log data (e.g., logging operational information of the computing device, such as data generated based on readings from sensor(s) 214), definitions, instructions, or any digital information generated or received by computing device 114a. For example, memory space 200 may store data that is used by one or more software programs (e.g., data relating to controller functions, data obtained during operation of the device, data to input to an AI model, data output by an AI model, or other data).

In certain embodiments, memory space 200 may store software executable by processor 206 to perform one or more methods, such as the methods discussed below. The software may be implemented via a variety of programming techniques and languages, such as C or MISRA-C, ASCET, Simulink, Stateflow, and various others. Further, it should be emphasized that techniques disclosed herein are not limited to automotive embodiments. Various other IoT environments may use the disclosed techniques, such as smart home appliances, network security or surveillance equipment, smart utility meters, connected sensor devices, parking garage sensors, and many more. In such embodiments, memory space 200 may store software based on a variety of programming techniques and languages such as C, C+, C++, C#, PHP, Java, JavaScript, Python, and various others.

Processor 206 may include one or more dedicated processing units, application-specific integrated circuits (ASICs), field-programmable gate arrays (FPGAs), graphical processing units, or various other types of processors or processing units coupled with memory space 200.

Computing device 114a may also include a communication interface 208, which may allow for remote devices to interact with computing device 114a. Communication interface 208 may include an antenna or wired connection to allow for communication to or from computing device 114a. For example, an external device (such as computing device 114b, computing device 116a, code interpreter 102, or any other device capable of communicating with computing device 114a) may send code to computing device 114a instructing computing device 114a to perform certain operations, such as changing software stored in memory space 200.

Computing device 114a may also include power supply 210, which may be an AC/DC converter, DC/DC converter, regulator, or battery internal to a physical housing of computing device 114a, and which may provide electrical power to computing device 114a to allow its components to function. In some embodiments, a power supply 210 may exist external to a physical housing of a computing device (i.e., may not be included as part of computing device 114a itself), and may supply electrical power to multiple computing devices (e.g., all controllers within a controller system, such as a device system 108a).

Computing device 114a may also include input/output device (I/O) 212, which may be configured to allow for a user or device to interact with computing device 114a. For example, I/O 212 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a microphone, a speaker, a haptic device, a camera, a button, a dial, a switch, a knob, a transceiver, an input device, an output device, or another I/O device configured to perform, or to allow a user to perform, any number of steps of the methods of the disclosed embodiments, as discussed further below.

Computing device 114a may also include sensor(s) 214, which may be configured to detect environmental characteristics associated with computing device 114 (a) (e.g., temperature, light, motion, voltage, or current). Sensor(s) 214 may associate a reading (e.g., a value) with an environmental characteristic and transmit the reading to processor 206 for further processing (e.g., analysis, input to a program or model). While FIG. 2 depicts exemplary computing device 114a, these described aspects of computing device 114a (or any combination thereof) may be equally applicable to any other device in network architecture, such as computing device 110b, computing device 110c, code interpreter 102, or network resource 104a.

FIG. 3 illustrates an exemplary pictographic representation of a code interpretation environment 300, which may be a single device or multiple devices. In the embodiment shown, code interpretation environment 300 includes code interpreter 102, which may be a computer, server, mobile device, special purpose computer, or any other computing device that may allow a user to perform any number of steps of the methods of the disclosed embodiments, as discussed further below. For example, code interpreter 102 may include a processor 302, which may be configured to execute instructions stored at memory 304. Processor 302 may include any or all characteristics of processor 206, discussed above. Memory 304 may include multiple memory components (e.g., a hard drive, a solid state drive, flash memory, random access memory) and/or partitions. Memory 304 may also store data (e.g., instructions) to be used in methods of the disclosed embodiments, as discussed further below. Memory 304 may include any or all characteristics of memory space 200, discussed above.

Memory 304 may include one or more datasets, which may be used to, for example, initialize, train, configure, update, reconfigured, and/or run a model (e.g., a machine learning model). For example, memory 304 may include model parameter data 306, which may include one or more parameters (e.g., hyperparameters, seed values, initialization parameters, node configurations, layer configurations, weight values) that may be usable to influence the configuration of a model. Memory 304 may also include model input data 308, which may include one or more data elements (e.g., values, vectors, matrices, strings) that may be configured to input to a model. Model input data 308 may include and/or be based upon programming code elements, consistent with embodiments discussed herein. Memory 304 may also include model output data 310, which may include data output from a model (e.g., one or more values, vectors, matrices, strings, probabilities). For example, model output data 310 may include a predictive value representing a probability of digital information being true and/or a highest probability among multiple probabilities (e.g., a probability associated with digital information predicted to achieve maximization of a metric).

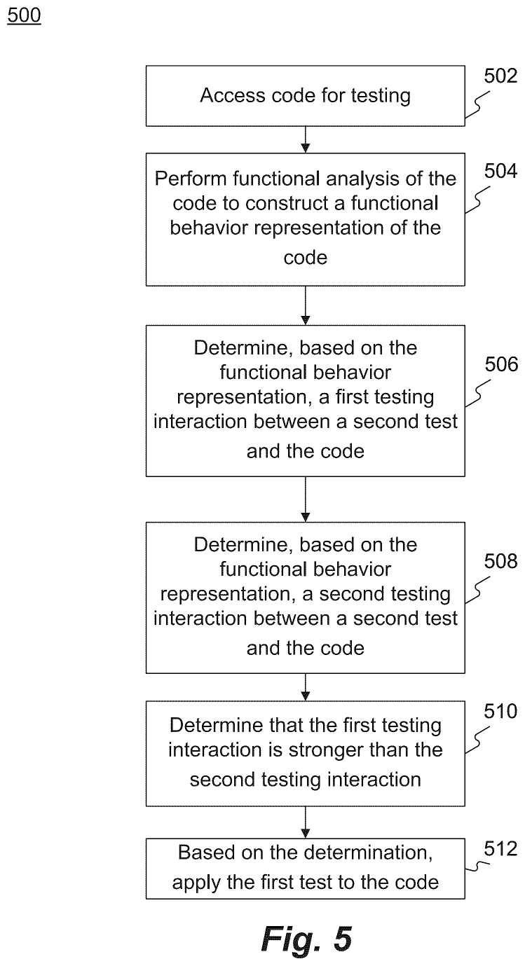

Memory 304 may also include one or more program(s) 312, which may be configured to perform (e.g., with use of processor 302) one or more operations discussed further herein (e.g., with respect to FIGS. 5-11). For example, a program 312 may include an amount of programming code that, when executed, causes processor 302 to perform an operation improving efficiencies in coding environments. In some embodiments, a program may be associated with an application.

Memory 304 may also include code 314, which may include at least one of compiled code, uncompiled code, executable code, unexecutable code, or any amount of programming information interpretable by a computing device. In some embodiments, code 314 may include a body of programming code capable of analysis or other processing according to embodiments disclosed herein (e.g., discussed with respect to FIGS. 5-11). Code 314 may also include code that is accessible and/or configured for analysis and/or alteration according to disclosed embodiments. For example, code 314 may include a body of programming code, such as a software change file (e.g., an update file) or a computer code program.

In some embodiments, code interpreter 102 may connect to a communication interface 316, which may be similar to communication interface 208 and/or I/O 212, described above. For example, communication interface 316 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a mouse, a microphone, a speaker, a haptic device, a camera, a button, a dial, a switch, a knob, a transceiver, an input device, an output device, or another device configured to perform, or to allow a user to perform, any number of steps of the methods of the disclosed embodiments, as discussed further below. Communication interface 316 may also allow code interpreter 102 to connect to other devices, such as other devices within code interpretation environment 300, other devices within a system 100, and/or devices external to system 100, such as a computing device 114a. In some embodiments, communication interface 316 (e.g., a network adapter, an ethernet interface, an antenna) may connect with database 318, which may also be connectable to a device other than code interpreter 102 (e.g., a device external to system 100), to communicate with database 318.

Code interpreter 102 may also connect to database 318, which may be an instance of a network resource, such as network resource 104a. In some embodiments, database 318 may be part of and/or may be connected to, remote system 103. In some embodiments, database 318 may be accessible by code interpreter 102 or remote system 103, but not both. Database 318 may store data to be used in methods of the disclosed embodiments, as discussed further below. For example, database 318 may maintain any number of models 320, which may be fully trained, partially trained, or untrained. Models 320 may be associated with respective specific input data, devices, and/or entities, consistent with the disclosed embodiments. Models 320 may include one or more of a statistical model, a regression model (e.g., one or more regression layers), a probabilistic model, a language model, an encoder-decoder model, a transformer model, a neural network (e.g., one or more neural network layers, a recurrent neural network, also called an RNN), a bag-of-words model, a Word2Vec model, a sequence-to-sequence model, or any other AI-based digital tool. It is appreciated that the human mind is not equipped to perform the operations for which model 320 is configured, given its arrangement and combination of model elements (e.g., nodes, layers, parameters, connections), as further demonstrated in model architecture 400. A model 320 may include a model configured to (e.g., trained to) predict data size, predict or analyze functional behavior of computer code, identify linker script syntax, scan executable code, or perform any other analytic or predictive operation discussed herein.

Database 318 may include any number of disk drives, servers, server arrays, server blades, memories, or any other medium capable of storing data. Database 318 may be configured in a number of fashions, including as a textual database, a centralized database, a distributed database, a hierarchical database, a relational database (e.g., SQL), an object-oriented database, or in any other configuration suitable for storing data. While database 318 is shown externally to code interpreter 102 (e.g., existing at a remote cloud computing platform, for example), it may also exist internally to it (e.g., as part of memory 304).

In some embodiments, database 318 may include device data 322, which may include operational data (e.g., log data, such as data based on execution of code on one or more computing devices) and/or program data (e.g., compiled code, uncompiled code, an executable program, an application) associated with one or more devices. In some embodiments, device data 322 may be in a format that is unrecognizable to a model, and may be converted to a format, arrangement, or representation that a model is configured to receive as input (e.g., model input data 308), which may bear no resemblance to the initial format and may not be understandable to a human.

In some embodiments, database 318 may include code 324, which may include any or all characteristics of code 314, discussed above. In some embodiments, code 324 may include code associated with (e.g., received from, designated for) multiple computing devices.

Code interpreter 102 may also be communicably connectable with a display 326, which may include a liquid crystal display (LCD), in-plane switching liquid crystal display (IPS-LCD), light-emitting diode (LED) display, organic light-emitting diode (OLED) display, active-matrix organic light-emitting diode (AMOLED) display, cathode ray tube (CRT) display, plasma display panel (PDP), digital light processing (DLP) display, or any other display capable of connecting to a user device and depicting information to a user. Display 326 may display graphical interfaces, interactable graphical elements, animations, dynamic graphical elements, and any other visual element, such as visual elements indicating digital information associated with a model (e.g., associated with training a model or model output), among others.

As shown in this exemplary depiction, code interpreter 102 may also be communicably connectable with remote system 103 (as is also shown in FIG. 1). Remote system 103 may include device data 328, which may share any or all characteristics of device data 322, discussed above. Remote system 103 may also include code 330, which may include any or all characteristics of code 314, discussed above

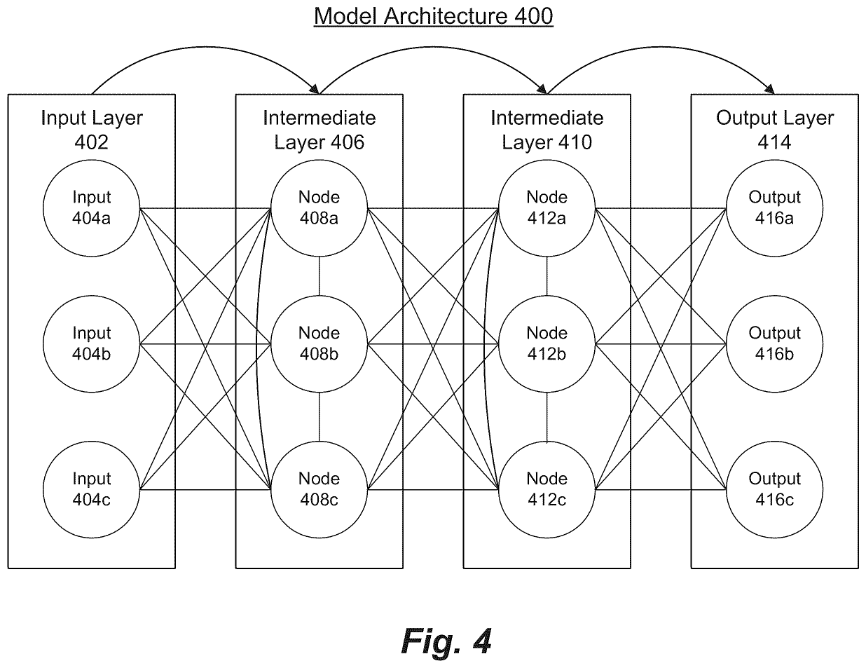

FIG. 4 illustrates an exemplary pictographic representation of a model architecture 400. Model architecture 400 may represent a structure for a model (e.g., a model 320, which may be an AI model), though many variations are possible, which may or may not include elements shown in FIG. 4. Model architecture 400 may include a number of model layers, which may be organized in a sequence or other arrangement, such as within a neural network or other machine learning model. A model layer may be, for example, a regression layer, a convolution layer, a deconvolution layer, a fully connected layer, a partially connected layer, a recurrent layer, a pooling layer, an activation layer, a sequence layer, a normalization layer, a resizing layer, a pooling layer, an unpooling layer, or a dropout layer. For example, model architecture 400 may include an input layer 402, which may include and/or be configured to receive one or more model inputs, such as input 404a, input 404b, and input 404c (which may be considered nodes), consistent with disclosed embodiments. Of course, other numbers or configurations of input layers and inputs are possible.

Model architecture 400 may also include one or more intermediate layers, such as intermediate layer 406 and intermediate layer 410. An intermediate layer may include one or more nodes, which may be connected (e.g., artificially neurally connected) to another node, layer, input, and/or output. For example, intermediate layer 406 may include nodes 408a, 408b, and 408c, which are shown with exemplary connections to input 404a, input 404b, input 404c, as well as to nodes included in intermediate layer 410—node 412a, node 412b, and node 412c. Of course, other numbers or configurations of intermediate layers and nodes are possible.

Model architecture 400 may also include an output layer 414, which may include one or more outputs and/or be configured to generate one or more model outputs, such as output 416a, output 416b, and output 416c (which may be considered nodes). As depicted in FIG. 4, inputs to a layered architecture may be influenced by a complex interconnected web of connections between nodes. In some embodiments, the connections may represent unidirectional relationships, bidirectional relationships, dependent relationships, interdependent relationships, correlative relationships, or any combination thereof. In some embodiments, one or more nodes may be activated or deactivated, which may be dependent on initialization parameters and/or training parameters of a model. A training parameter may include, for example, a number of nodes, a configuration of nodes, types of nodes within the configuration, a number of layers, a configuration of layers, types of nodes within the layers, a number of training epochs, a sequence of training operations, or any other digital information that can influence the performance of training a model. In some embodiments, different nodes (or other model parameters) may be associated with different weights (which may also be considered a model parameter). A configuration of a trained model may be dependent on post-training parameters, such as a number of nodes, a configuration of nodes, types of nodes within the configuration, a number of layers, a configuration of layers (e.g., connections between layers and nodes), types of nodes within the layers, or any other digital information that can influence the performance of a trained model. The exemplary processes described below may be carried out using a model including any or all characteristics of model architecture 400. Nodes and layers may be considered model parameters. As shown in FIG. 4, different nodes in different layers, or the same layer, may be connected in a number of different ways. The connections shown are exemplary, and fewer or additional connections may exist.

FIG. 5 shows an exemplary process 500 for reducing processing load for software testing. In accordance with disclosed embodiments, process 500 may be implemented in system 100 depicted in FIG. 1, or any type of network environment. For example, process 500 may be performed by at least one processor (e.g., processor 302), memory (e.g., memory 304), and/or other components of code interpreter 102 (e.g., components of one or more code interpreters 102), or by any computing device or IoT system. All or part of process 500 may be implemented in conjunction with all or part of other processes discussed herein (e.g., process 700, process 900, process 1000, or process 1100). For example, a device (e.g., at least one processor) may implement all or part of process 500 to reduce processing load for testing computer code, and may then implement all or part of process 700 to generate a linker script file for the computer code.

At step 502, process 500 may access code for testing. Code for testing may include a program, an application, a file (e.g., an executable file), a module, a script, a body of programming code, or any other digital information with influencing device operation. Code for testing may be compiled or uncompiled. Code for testing may also be executable or non-executable. In some embodiments, the code for testing may be configured for execution on a controller (e.g., a computing device 114a). In some embodiments, the accessed code may be a first version of the code, which may include at least one function changed relative to a second version of the code. Accessing code for testing may include requesting code, receiving code, retrieving code (e.g., from local or remote storage), generating code, or preparing code into a format suitable for functional analysis.

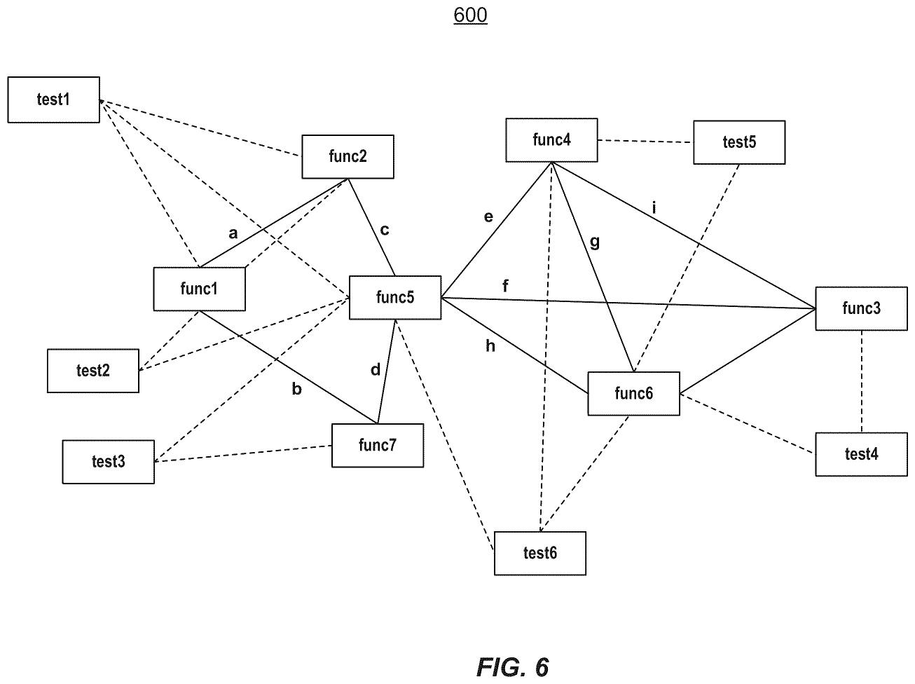

At step 504, process 500 may perform functional analysis of the code to construct a functional behavior representation of the code. Performing functional analysis of the code may include executing the code, segmenting the code into functional elements (e.g., functions, methods, processes, objects, and/or combinations thereof), simulating execution of the code, generating an alternate representation of the code (e.g., configured for analysis by a particular program, device, model, etc.), analyzing the code, associating functional characteristics with respective portions of the code, or performing any operation to express functionality of at least a portion of the code. A functional behavior representation of the code may include a call graph, a chart, a web, an arrangement of symbols (e.g., symbols and functional relationships connecting the symbols), a combination of functional code elements and functional influences (e.g., relationships) between the functional code elements, or any digitized structure that expresses effects caused by the code. For example, in embodiments where the functional behavior representation of the code includes symbols, the symbols may include functions, and the functional behavior representation of the code may include a number of calls between the functions. As another non-exclusive example, one example of a functional behavior representation of the code is shown in FIG. 6, discussed further below. In some embodiments, the functional behavior representation of the code may include symbols represented by the code and relationships (e.g., dependencies, interdependencies, influences) between the symbols. A symbol may include or represent a function, a variable, a buffer, an object, an argument, a call, a software method, a device (e.g., a controller), or any other semantic portion of code (whether compiled or uncompiled).

In some embodiments, performing the functional analysis of the code may include applying at least one of static (e.g., without running the code) or dynamic (e.g., based on running the code) analysis to the code. In some embodiments, the static or dynamic analysis may identify and/or be configured to identify, at least one of a number of calls performed, a processor-off metric, processor-on metric, an amount of memory used, a symbol represented by the code, a relationship between a plurality of symbols, or hardware-sourced data correlated with the code (e.g., operational and/or execution data from one or more devices based on executing the code). In some embodiments, the hardware-sourced data may be correlated with at least one time of execution of at least one function associated with the code. Additionally or alternatively, the hardware-sourced data may include at least one of a sensor value, a voltage value, or a temperature value.

In some embodiments, at least one of the symbols (e.g., a symbol identified by static or dynamic analysis, a symbol included in the functional behavior representation of the code) may be a function, a variable, a buffer, a call, an object, or a segment of code. A symbol may be included in the code (e.g., the functionally analyzed code) or may be a representation of at least a portion of the code.

At step 506, process 500 may determine, based on the functional behavior representation, a first testing interaction between a first test and the code. A test, such as the first test, may include a sequence of inputs (e.g., scripts) configured to determine effects of the code, capabilities of the code, memory areas the code is configured to access, other code that the code is configured to interact with, other devices that the code may cause a device (e.g., upon which the code is executing) to interact with, or vulnerabilities of the code. For example, the first test may be configured to determine if code includes a vulnerability or operates outside certain thresholds (e.g., accesses restricted data or memory locations, operates according to a threshold speed, operates according to a threshold memory usage, operates according to a threshold bandwidth usage, performs one or more designated actions, achieves one or more effects in a computing environment, etc.). Additionally or alternatively, the first test may be configured to determine whether the code includes one or more types of errors, bugs, and/or inefficiencies. A test may be associated with (e.g., executable by) a particular program, application, or code segment (e.g., a testing program, a portion thereof, etc.).

A testing interaction may include an amount of the code used by the test, an amount of the code that the test is configured to use, an amount of code impacted (or predicted to be impacted, such as by using the test or a model) by the test, an amount of the test used based on applying it to the code, an amount of the test predicted (e.g., by a test or model) to be used when applied to the code, or any representation of a degree to which the code is implicated by the test. In some embodiments, a testing interaction may be based on one or more of a number of symbols in the code that were used by the test, a frequency of use of one or more symbols in the code that were used by the test, an execution time of the test, one or more dependencies between symbols, one or more interdependencies between symbols, any degree of use of an amount of the code, or any combination thereof.

Determining a first testing interaction based on the functional behavior representation may include analyzing the first test to determine interactions the test has (or is predicted to have, when applied) to symbols or other representations of code in the functional behavior representation. For example, process 500 may determine that the first test is predicted (e.g., using a test and/or model) to interact with 75% of the symbols represented in the functional behavior representation and/or a number of interactions with each of those symbols. In some embodiments, determining a first testing interaction based on the functional behavior representation may include identifying symbols impacted indirectly by the first test. For example, process 500 may determine that the first test impacts 10 symbols represented in the functional behavior representation and may also determine that those 10 symbols influence (e.g., have dependencies or interdependencies with) 6 additional symbols represented in the functional behavior representation. As another non-exclusive example, process 500 may determine that the first test interacts with functions having a particular sum of importance ranking values (e.g., each function having a respective importance ranking value), and the first testing interaction may include, or be represented by, the sum of the importance ranking values. An example illustration of testing interaction information is depicted in FIG. 6, discussed further below.

At step 508, process 500 may determine, based on the functional behavior representation, a second testing interaction between a second test and the code. A second test may be different from the first test, such as where the second test may be configured to test a different aspect of the code. For example, the second test may be a vulnerability test and the first test may be an operational execution time or feasibility test. In some embodiments, at least one of the first test or the second test may be an integration test, a production test, a system test, or a unit test.

Aside from relating to the second test instead of the first test, the second testing interaction between the second test and the code may include any or all characteristics of first testing interaction between the first test and the code (e.g., may include any representation of a degree to which the code is implicated by the test), discussed above. Also, aside from relating to the second test instead of the first test, determining the second testing interaction may include any or all characteristics of determining the first testing interaction, discussed above.

In some embodiments, the first testing interaction and/or the second testing interaction may be determined based on an identification of a change to a function represented in the code. For example, the code may be a changed version of an earlier version of code, and the changed function represented in the changed version of the code may cause or influence how the first test and/or second test may interact with the code. In some embodiments, the first testing interaction and/or the second testing interaction may be determined based on a relationship between the changed function and at least one other function. For example, process 500 may determine that the changed function has relationships with three other functions, the first test has a first interaction (e.g., predicted interaction, relationship) with the changed function and the three other functions, and the second test has a second interaction (e.g., predicted interaction, relationship) with the changed function and the three other functions.

In some embodiments, determining the first testing interaction and the second testing interaction may include scoring the first test and the second test. Scoring the first test and the second test may include associating respective values with the first test and the second test that indicate a degree to which each test is involved with the code. For example, determining the first testing interaction and the second testing interaction may include scoring the first test and the second test based on: (1) a first set of interactions between the first test and both the changed function and the at least one other function and (2) a second set of interactions between the second test and both the changed function and the at least one other function.

As discussed above, the accessed code may be a first version of the code, which may include at least one function changed relative to a second version of the code. In some embodiments, process 500 may also include applying the first test to the second version of the code to determine initial first test behavior and applying the second test to the second version of the code to determine initial second test behavior. Applying a test to code may include providing the code as input to the test and executing the test, and/or determining portions of the code implicated by the test. An initial test behavior may include a set of tracked interactions the test has with the code, which may include one or more portions of the code impacted by the test, when the one or more portions of code where impacted, and/or a result associated with the test as applied to the one or more portions of code (e.g., results indicating whether the one or more portions of code passed or failed the test). An initial test behavior may be based on operations performed by the code, operations predicted to be performed by the code (e.g., predicted using the test and/or a model), and/or performance metrics associated with performance of the code according to the test. The first testing interaction may be based on the initial first test behavior and the second testing interaction may be based on the initial second test behavior.

At step 510, process 500 may determine that the first testing interaction is stronger than the second testing interaction. Determining that the first testing interaction is stronger than the second testing interaction may include comparing the first testing interaction to the second testing interaction, comparing portions of the first testing interaction to portions of the second testing interaction. In some embodiments, the first testing interaction may be considered stronger than the second testing interaction if the code is implicated by a larger degree by the first test than the second test. For example, the first test may impact (directly, indirectly, or a combination of both) 80% of the symbols represented by the functional behavior representation and the second test may impact (directly, indirectly, or a combination of both) 60% of the symbols represented by the functional behavior representation. As another non-exclusive example, process 500 may determine that the first test interacts with functions having a first sum of importance ranking values and that the second test interacts with functions having a second sum of importance values (e.g., each function having a respective importance ranking value, each testing interaction including or being represented by the associated sum of importance values), and that the first sum exceeds the second sum.

At step 510, process 500 may, based on the determination that the first testing interaction is stronger than the second testing interaction, apply the first test to the code. Applying the first test to the code may include determining whether the code passes one or more assessments included within the test, such as assessments for determining particular types of errors in the code, determining particular types of bugs in the code, determining an amount of computing resources used by (or predicted to be used by, such as by using a test and/or a model) the code, determining an execution time (or predicted execution time) of the code, or determining any other risk, incompatibility, flaw, or inefficiency of the code.

In some embodiments, process 500 may include performing some steps multiple times, such as with respect to a first test, a second test, a third test, or any number of tests. For example, process 500 may determine respective testing interactions for 12 tests and may determine an order of those tests based on testing interaction strength. Process 500 may apply a test with a strongest testing interaction first, then a test with a second strongest testing interaction second, and so on, concluding with a test that was determined to have the least strongest testing interaction.

In some embodiments, process 500 may include recalibrating the initial first test behavior based on the determined first test interaction and recalibrating the initial second test behavior based on the determined second test interaction. Recalibrating an initial test behavior may include re-configuring a test (e.g., the first test or the second test), adding code to a test, removing code from a test, changing an order of operations within a test, or any other change applied to a test to cause the test to operate differently when applied to code.

FIG. 6 depicts a visualization 600 of function relationships and programming code test selection, consistent with disclosed embodiments. In visualization 600, multiple exemplary functions, which may be associated with an amount of code (e.g., code for testing), are depicted: func1, func2, func3, func4, func5, func6, and func7. These functions have exemplary relationships with one another, represented by the solid lines labeled a, b, c, d, e, f, g, h, i, respectively. Of course, depending on the code with which the functions are associated, any number and configuration of functions and relationships may be present. In some embodiments, the relationships between the functions may have different strengths, different frequencies, and/or different directionality (e.g., unidirectional dependencies, bi-directional interdependencies). Visualization 600 also depicts multiple exemplary tests: test1, test2, test3, test4, test5, and test6. Consistent with disclosed embodiments, a test may implicate one or more portions of code and/or portions of a functional behavior representation, such as functions. For example, in visualization 600, the tests have impacts that implicate different functions, which are depicted by the dashed lines. As shown in FIG. 6, and as discussed above, different tests may implicate different groups of functions. For example, test1 implicates functions func1, func2, and func5, whereas test6 implicates func4, func5, and func6.

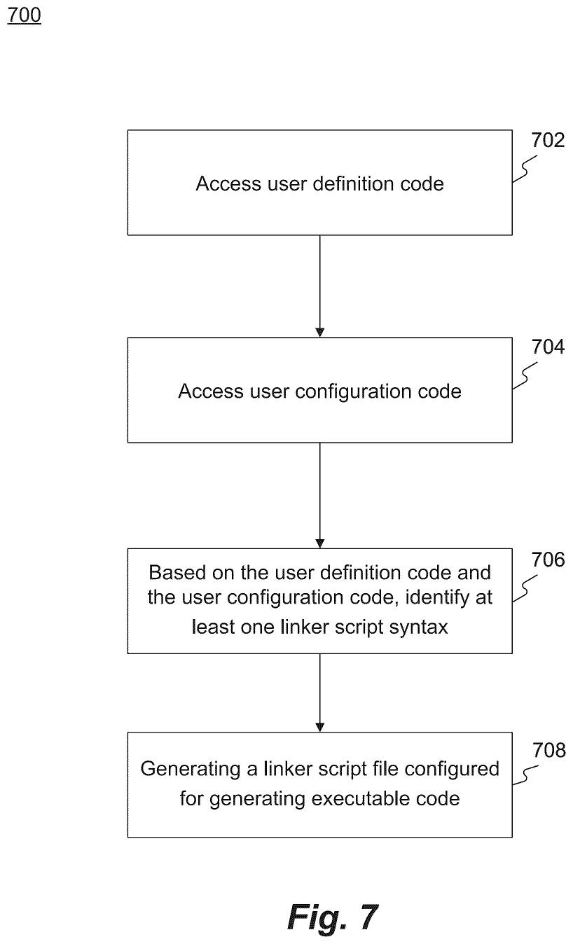

FIG. 7 shows an exemplary process 700 for generating a linker script file. In accordance with disclosed embodiments, process 700 may be implemented in system 100 depicted in FIG. 1, or any type of network environment. For example, process 700 may be performed by at least one processor (e.g., processor 302), memory (e.g., memory 304), and/or other components of code interpreter 102 (e.g., components of one or more code interpreters 102), or by any computing device or IoT system. All or part of process 700 may be implemented in conjunction with all or part of other processes discussed herein (e.g., process 500, process 900, process 1000, or process 1100). For example, a device (e.g., at least one processor) may implement all or part of process 700 to generate a linker script file for the computer code, and may also implement all or part of process 1000, as discussed below, to determine a software vulnerability associated with the computer code.

At step 702, process 700 may access user definition code. User definition code may include a file, a chart, structured data, or any other representation of defined attributes and/or parameters for a body of code, such as a delta file, a code change file (e.g., an update file), a patch, a program, an application, or a module. For example, in some embodiments, the user definition code may include at least one of a comma-separated values (CSV) file, a text file, an Extensive Markup Language (XML) file, a table, or a digital data structure. User definition code may define attributes and/or parameters such as an address table size, a software size (e.g., a patch size), a memory address location (e.g., memory start location), an allocation segment and/or size (e.g., of memory), a variable, an argument, or a relationship to other code (code for which the user definition code does not define attributes and/or parameters). For example, in some embodiments, the user definition code may indicate at least one of: a memory region name, a memory address, a symbol type, or a symbol name. Accessing the user definition code may include requesting, receiving, decrypting, decompressing, and/or retrieving (e.g., from local or remote storage) the user definition code.

At step 704, process 700 may access user configuration code. User configuration code may include a file, a chart, structured data, or any other representation of defined settings for a body of code, such as a delta file, a code change file (e.g., an update file), a patch, a program, an application, or a module. User configuration code may define settings such as a programming language, a file type, a path, a source, a directory, a library, or any other setting needed for correctly executing code. In some embodiments, user configuration code may define one or more of memory regions, section placement, symbol values, output sections, and/or input files, discussed further below with respect to the linker script file.

In some embodiments, the user definition code and the user configuration code may be part of a same or different data structure (e.g., part of a single file, or separate files). In embodiments where the user definition code and the user configuration code are part of different data structures, they may be stored in different locations (e.g., on different devices).

In some embodiments, at least one of the user definition code or the user configuration code may be associated with at least one of differing communication protocols (e.g., for wireless or wired electronic communications), differing operating systems, differing middleware, differing application software, or differing development environments.

At step 706, process 700 may, based on the user definition code and the user configuration code, identify at least one linker script syntax. A linker script syntax may include a format, parameter, and/or structure for a linker script file, which may constrain the generation of a linker script file. The at least one linker script syntax may include, for example, an order of commands, a symbol assignment, or a relationship. Identifying the at least one linker script syntax may include determining, constructing, or selecting the at least one linker script syntax. The at least one linker script syntax may be based on the user definition code and the user configuration code. For example, the user definition code and the user configuration code may operate as constraints to process 700 identifying the at least one linker script syntax. By way of further example, the user definition code and the user configuration code may constrain the syntax formatting that process 700 can use in constructing the at least one linker script syntax.

By way of additional example, a linker script may include one or more commands, such as “SECTIONS,” which configures the linker to organize the program's sections in a particular way for a final file. For example, a section of script may appear as:
SECTIONS{.text:{*(.text)
{*(.data)}.bss:{*(.bss)}}

Script such as this may configure the linker to cause the code (text), initialized data (data) and uninitialized data (bss) to be grouped together, in that order, in a final executable file. A linker script of the disclosed embodiments may operate as a map to a linker, leading to accurate code configuration, causing programs to operate as expected on intended devices.

At step 708, process 700 may generate a linker script file, which may include at least one of a formatting definition, a directory definition, an address location, or an identification of other code (e.g., another file, an executable, etc.). In some embodiments, the linker script file may be generated based on the at least one linker script syntax. For example, the linker script file may be generated such that it adheres to the at least one linker script syntax. In some embodiments, the linker script file may be based on the user definition code and the user configuration code. For example, the user definition code and the user configuration code may influence and/or control structure and/or content of the linker script file. Additionally or alternatively, the linker script file may be based on information accessed from a syntax database (e.g., a database storing different portions of syntax information associated with multiple respective computing environments). By way of further example, the linker script file may be configured for a specific programming language, which may have been included in the user definition code and/or the user configuration code. In some embodiments, the linker script file may indicate (e.g., include a definition of, include an attribute identifying, etc.) at least one of: a memory layout, a relationship between executable code and data, or a memory write location associated with the executable code. In some embodiments, generating the linker script file may be compiler-independent, such that process 700 (e.g., a device implementing process 700) can generate a linker script file regardless of compiler associated with the user definition code, the user configuration code, or any other code involved in process 700.

In some embodiments, the linker script file may be usable to control how a program is turned into an executable. For example, the linker script file may define one or more of memory regions (e.g., where different parts of the program should be placed in memory), section placement (e.g., an organization of the program's code and/or data in memory), symbol values (e.g., addresses assigned by the linker script file to functions and variables), output sections (e.g., a particular combination of different parts of the program into a single file), and/or input files (e.g., which files and/or libraries are included in a final program). A correct configuration of one or more of these, as defined by a linker script file, can help ensure that the program will run correctly on its intended hardware (e.g., not cause malfunctions, safety problems, etc.).

In some embodiments, the linker script file may be configured for generating executable code. For example, the linker script file may be configured to be interpretable by a program (e.g., a compiler), such that the program can generate executable code based on (e.g., using, being dependent upon, being derived from, being constrained by) the linker script file. In some embodiments, the linker script file may be generated to be compiler-independent, such that the linker script file may be configured for use with multiple different compilers. In some embodiments, the executable code may be an executable binary. By generating a linker script file that is based on (e.g., constrained by) user definition code and user configuration code, the likelihood for errors in the linker script file can be reduced (allowing for more accurate generation of executable code based on the linker script file), reducing the amount of broken code, which can impair device functionality and/or delay device updates, which can involve critical software and hardware security vulnerabilities. The linker script file can also be generated more rapidly, reducing usage of computing and network resources.

In some embodiments, generating the linker script file may include determining interdependent portions of code associated with at least one of the user definition code or the user configuration code. For example, process 700 may include determining interdependent portions of code that are part of a program, application, file, executable, or programming code project. Portions of code may be interdependent if they are configured to influence each other to some extent, such as where some portions are dependent upon other portions, where some portions call on other portions, or where some portions require information from other portions to function properly.

In some embodiments, process 700 may include generating the executable code based on the linker script file. For example, process 700 may generate an executable file (e.g., a binary executable file) that is configured to cause changes to code on a device. The changes may be based on the user definition code, the user configuration code, information from a syntax database, and/or a body of programming code representing changes to be made to device code (e.g., uncompiled code, a program, an update, a module, etc.).

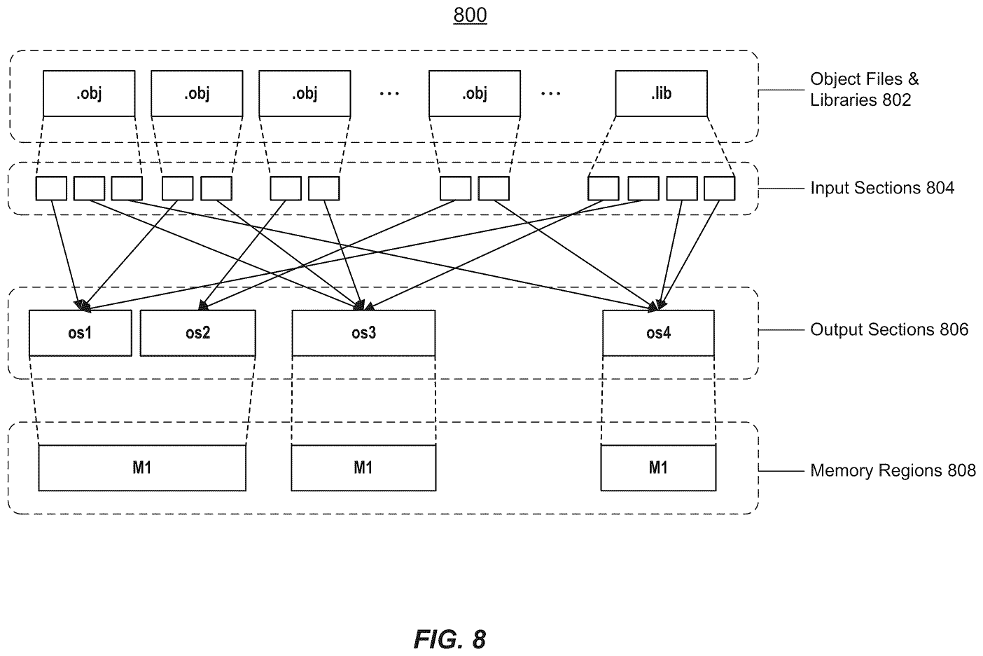

FIG. 8 depicts a visualization of a linker file configuration 800, consistent with disclosed embodiments. As shown in FIG. 8, multiple object files and libraries 802 may correspond to multiple associated input sections 804, which may include one or more segments of code. The input sections 804 may be associated with, correspond to, and/or be linked to output sections 806, which may include one or more segments of code generated based on the input sections 804. In some embodiments, the input sections 804 may include a script section such as “SECTIONS,” described above. Additionally or alternatively, input sections 804 may include a “MEMORY” section (e.g., a command describing memory available in a target system, helping a linker perform proper allocation), “Symbols” (e.g., references to code and/or data, helping identifying starting locations of code and/or locations of variables), “Expressions” (e.g., integers or other information, which may be usable for arithmetic operations within a script, and which can reference, define, or create global variables), and/or “Commands” (e.g., “INPUT” and/“GROUP,” which can be used to select and group input files and/or name output files).

The output sections 806, which may include one or more segments of code, may be associated with (e.g., configured for storage at) memory regions 808. Memory regions 808 may be memory regions on a device, such as a computing device (e.g., computing device 112a). In some embodiments, a linker script file (e.g., generated according to process 700) may include digital information expressing or influencing (e.g., controlling, defining) the configuration of and/or relationships between object files and libraries 802, input sections 804, output sections 806, and/or memory regions 808. It is appreciated that the human mind is not equipped to grasp the information expressed by a linker script file or a process used to generate it, given the numerosity and complexity of the object files and libraries 802, input sections 804, output sections 806, and memory regions 808, and their relationships with one another.

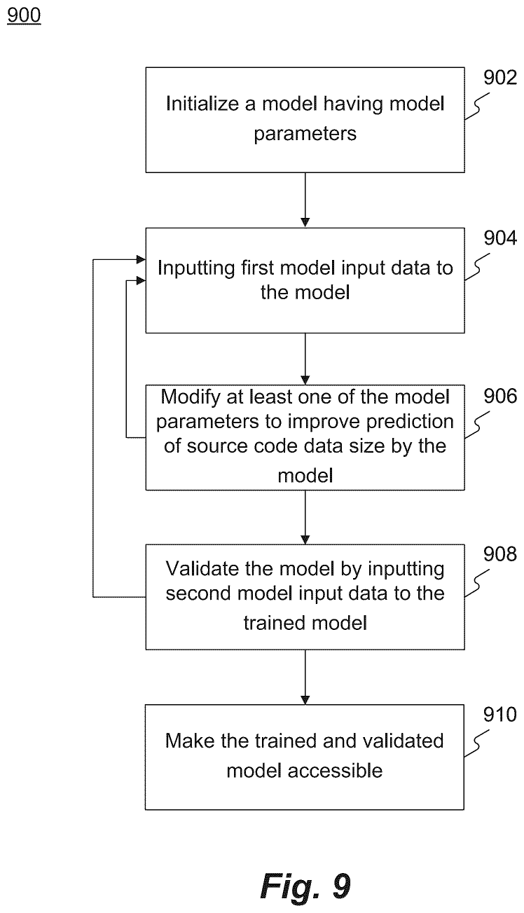

FIG. 9 shows an exemplary process 900 for training a model to predict data size. In accordance with disclosed embodiments, process 900 may be implemented in system 100 depicted in FIG. 1, or any type of network environment. For example, process 900 may be performed by at least one processor (e.g., processor 302), memory (e.g., memory 304), and/or other components of code interpreter 102 (e.g., components of one or more code interpreters 102), or by any computing device or IoT system. All or part of process 900 may be implemented in conjunction with all or part of other processes discussed herein (e.g., process 500, process 700, process 1000, or process 1100). For example, a device (e.g., at least one processor) may implement all or part of process 900 to predict source code data size for computer code, and may also implement all or part of process 700 to generate a linker script file associated with the computer code and/or configured for generating the computer code.

At step 902, process 900 may initialize a model, which may have model parameters. The model may include a machine learning model or other type of AI model, such as a model 320. A model parameter may include at least one of a value (e.g., a seed value for the model), a hyperparameter, a model weight, a variable setting, a portion of the model, a vector, a matrix, and/or a configuration parameter (e.g., a number of, arrangement of, and connections between model layers and/or nodes). In some embodiments, initializing the model may include determining one or more of the model parameters, accessing one or more of the model parameters, or retrieving one or more of the model parameters. Additionally or alternatively, initializing the model may include accessing the model, retrieving the model, or performing any other action to prepare the model to accept model input data. In some embodiments, initializing the model may be based on model parameter data 306.

In some embodiments, process 900 may include training the model to predict source code data size, such as by performing any combination of steps 904, 906, and 908, discussed further below.

At step 904, process 900 may input first model input data to the model. The first model input data may include a first set of source code parameters associated with a data size parameter associated with a first source code. The first source code may be or represent a portion or entirety of a computer code program, which cannot be fully grasped by the human mind. In some embodiments, the first source code be configured to implement (e.g., install) a program or software change on a device, such as a controller. The first set of source code parameters may include at least one of a number of functions, a configuration of functions, a number of lines of code, a number of variables, a configuration of variables, a number of calls, a number of programming methods, a configuration of programming methods, a number of symbols, a configuration of symbols, or any description of the first source code that does not include a data size associated with the first source code. For example, in some embodiments, the first set of source code parameters may include at least one of: a version identifier associated with the first source code, a number of symbols associated with the first source code, a starting date associated with the first source code (e.g., a release date of the first source code), a current date (e.g., a date when process 900 is implemented), or a time since a starting date associated with the first source code. A symbol may include or represent a function, a variable, a buffer, an object, an argument, a call, a software method, a device (e.g., a controller), or any other semantic portion of code (whether compiled or uncompiled).

In some embodiments, the first set of source code parameters may include a flash memory size associated with the first source code. For example, the first set of source code parameters may include a flash memory size associated with a device for which the first source code is configured for implementation (e.g., installation). The flash memory size may include, for example, a total flash memory size, an available flash memory capacity, a flash memory partition size, or an allocation size of flash memory, etc.

In some embodiments, the first set of source code parameters may include a random access memory (RAM) size associated with the first source code. For example, the first set of source code parameters may include a RAM size associated with a device for which the first source code is configured for implementation (e.g., installation). The RAM size may include, for example, a total RAM size, an available RAM capacity, a RAM partition size, or an allocation size of RAM, etc.

A data size parameter may include a file size (e.g., a binary size), a program size, a compiled code size, an uncompiled code size, or any other quantification of storage space associated with the first source code. In some embodiments, the data size parameter may be expressed in bits, bytes, nibbles, and/or words (e.g., corresponding to a memory bus width). In some embodiments, process 900 may input first model input data to the model that include a first set of source code parameters associated with multiple data size parameters associated with a first source code. In some embodiments, a data size parameter may be associated with a particular device (e.g., computing device 114a), a particular memory component (e.g., memory space 200), and/or a particular type of device (e.g., a make and/or model of controller). For example, a data size parameter may be configured (e.g., sized, selected, determined, set) to facilitate implementation of a program or software change represented by the first source code on a device.

In some embodiments, the data size parameter associated with the first source code may comprise a size of an address table. In some embodiments, the address table is sized to accommodate the first source code. For example, the size of the address table may correspond to a space in memory (e.g., a memory allocation) of a computing device (e.g., memory space 200). In some embodiments, the address table may be associated with a differential update file, which may be generated based on a multidimensional software comparison. A differential update file may include a delta file, which may include a plurality of deltas corresponding to memory locations the delta file is configured to update. A multidimensional software comparison may include a comparison that compares different representations of software, such as a binary representation, a source code representation, a map file representation, a compiled code representation, an uncompiled code representation, or a code functionality representation.

In some embodiments, the data size parameter associated with the first source code may include at least one of a scratchpad size, a patch size, or a keep section. A scratchpad size, patch size, and/or keep size may be associated with a particular device (e.g., computing device 114a), a particular memory component (e.g., memory space 200), and/or a particular type of device (e.g., a make and/or model of controller).

At step 906, process 900 may modify at least one of the model parameters to improve prediction of source code data size by the model. Modifying at least one of the model parameters may include adding a model parameter to the model, removing a model parameter from the model, or changing an existing model parameter of the model. For example, modifying at least one of the model parameters may include changing a model weight associated with defining a correlation between a source code parameter and a data size parameter. In some embodiments, process 900 may include performing steps 904 and 906 in an iterative fashion (e.g., according to a number of training epochs), to improve model performance (e.g., predictive accuracy of the model). For example, process 900 may include inputting model input data to the model (e.g., step 904), analyzing an output generated by the model in response to the first model input data (e.g., scoring the output or comparing the output to a threshold), and modifying at least one of the model parameters based on the analysis of the output.

At step 908, process 900 may validate the model by inputting second model input data to the trained model (e.g., trained according to step 904 and 906). The second model input data may include a second set of source code parameters associated with a data size parameter of a second source code. At least one of the second set of source code parameters may differ from the first set of source code parameters. The second set of source code parameters may include any or all of the types of source code parameters described above with respect to the first set of source code parameters. For example, the second set of source code parameters may include a description of the second source code that does not include a data size associated with the second source code. In some embodiments, the first set of source code parameters and the second set of source code parameters may include a same parameter type combination. For example, both the first set of source code parameters and the second set of source code parameters may include a number-of-functions parameter and a number-of-calls parameter. At least a portion of the second source code may be different from the first source code. In some embodiments, the first source code may include a first computer code program, and the second source code may include a second computer code program different from the first computer code program. The second model input data may include some or none of the first model input data. In some embodiments, the first model input data and the second model input data may be included in a common dataset.

Validating the model may include analyzing an output generated by the model in response to the second model input data (e.g., scoring the output or comparing the output to a threshold), and modifying at least one of the model parameters based on the analysis of the output. Analyzing the output generated by the model in response to the second model input data may include quantifying the model's performance based on the output and comparing the performance quantization to a performance metric. In some embodiments, model training may be terminated, continued, or re-initiated based on the comparison. For example, if the performance quantization is below the performance metric, model training may be continued.

At step 910, process 900 may make the trained and validated model accessible. Making the model accessible may include storing the model (e.g., in database 318), encrypting the model, labeling the model (e.g., with a title and/or timestamp), transmitting the model (e.g., to remote system 103), and/or notifying a device that the model is accessible (e.g., remote system 103). Additionally or alternatively, process 900 may associate model input data with the trained and validated model. For example, if a model is trained on input data that includes only source code parameters associated with a particular programming language, the model may be associated with a label, tag, or other indicator that it is associated with the particular programming language. As another example, if a model is trained on input data that includes only source code parameters associated with a particular device make and/or model, the model may be associated with a label, tag, or other indicator that it is associated with the make and/or model.

In some embodiments, process 900 may include applying the validated model to third model input data to predict a data size parameter of a third source code. The third model input data may be associated (e.g., describe an aspect of) with the third source code. The third set of source code parameters may include any or all of the types of source code parameters described above with respect to the first set of source code parameters. For example, the third set of source code parameters may include a description of the third source code that does not include a data size associated with the third source code. Process 900 may also include automatically allocating memory space based on the predicted data size parameter of the third source code. For example, process 900 may include allocating a portion of memory within memory space 200. As another example, process 900 may include determining a portion (e.g., amount and/or position) of memory within memory space 200 and associating the determined portion with the third source code (e.g., such that the third source code may be implemented on a device using the determined portion).

In some embodiments, the model may be trained (e.g., based on process 900) to correlate a larger number of symbols with a larger source code data size and/or to correlate a longer amount of time since a starting date associated with the first source code with a larger source code data size. For example, based on a training procedure (e.g., process 900), the model may learn associations (e.g., relationships, influences, correlations) between source code attributes (e.g., symbol information, date information) and source code data sizes. In some embodiments, the model may be trained to use one or more learned correlations to predict a source code data size based on source code parameters (e.g., that do not include the source code data size).

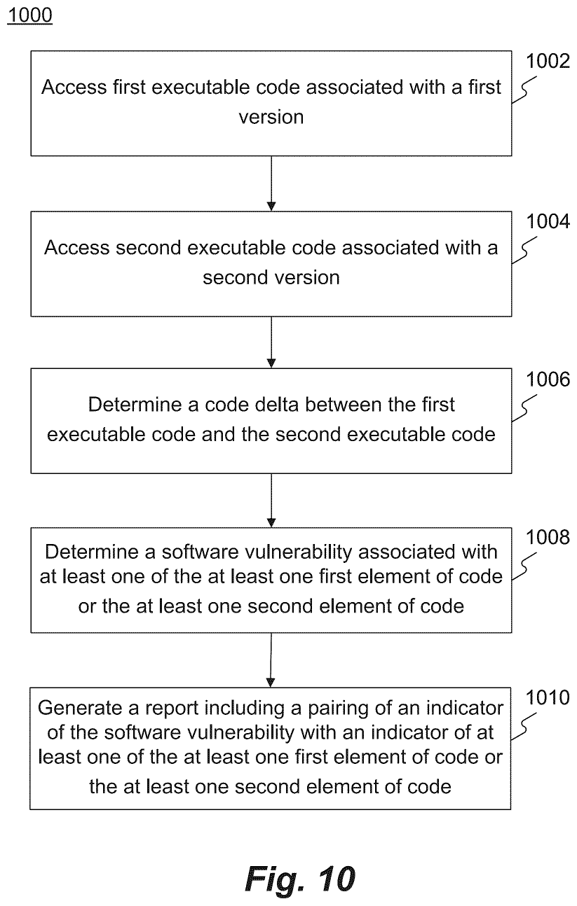

FIG. 10 shows an exemplary process 1000 for analyzing software build changes. In accordance with disclosed embodiments, process 1000 may be implemented in system 100 depicted in FIG. 1, or any type of network environment. For example, process 1000 may be performed by at least one processor (e.g., processor 302), memory (e.g., memory 304), and/or other components of code interpreter 102 (e.g., components of one or more code interpreters 102), or by any computing device or IoT system. All or part of process 1000 may be implemented in conjunction with all or part of other processes discussed herein (e.g., process 500, process 700, process 900, or process 1100). For example, a device (e.g., at least one processor) may implement all or part of process 1000 to analyze build changes and associated software vulnerabilities for computer code, and may also implement all or part of process 1100 to generate or update a security patch file.

At step 1002, process 1000 may access first executable code associated with a first version. Executable code may include at least one of a function, a command, an operation, a module, a program, an application, a symbol, or other computer language for causing a device action. A symbol may include or represent a function, a variable, a buffer, an object, an argument, a call, a software method, a device (e.g., a controller), or any other semantic portion of code (whether compiled or uncompiled). The first executable code may correspond to the first version, represent the first version, and/or be labeled with an indicator of the first version.

At step 1004, process 1000 may access second executable code associated with a second version. The second version may be different from the first version, such as by having a different number or arrangement of symbols. In some embodiments, the second version may be a changed version of the first version. For example, the second executable code may be a changed version of the first version of executable code.

At step 1006, process 1000 may determine a code delta between the first executable code and the second executable code. A code delta may include one or more code differences (e.g., deltas) between the first executable code and the second executable code. Code differences may include differences in compiled code (e.g., binary differences), differences in uncompiled code (e.g., source code differences), map file differences, and/or functional differences. In some embodiments, determining a code delta between the first executable code and the second executable code may include comparing at least a portion of the first executable code and at least a portion of the second executable code (e.g., comparing code semantics, code syntax, and/or code placement) and/or comparing functionality between the first executable code and the second executable code. Additionally or alternatively, determining a code delta between the first executable code and the second executable code may include comparing at least a portion of an abstract syntax tree (AST) (or other representation of code) of the first executable code with at least a portion of an AST (or other representation of code) of the second executable code. In some embodiments, a code delta may be based on a change of at least one first element of code in the first executable code to at least one second element of code in the second executable code. For example, a first function in the first executable code (e.g., a first element of code) may have been changed into a second function in the second executable code (e.g., a second element of code), and the delta file may be based on the change of the first function to the second function. In some embodiments, the code delta may be based on multiple changes to multiple elements of code between the first executable code and the second executable code. In some embodiments, determining a code delta may include determining only substantive functional differences between the first executable code and the second executable code (e.g., excluding differences with no substantive code-semantic differences).

Additionally or alternatively, determining a code delta between the first executable code and the second executable code may include determining at least one of a symbol or a 3rd-party package added or removed in the second executable code relative to the first executable code. A symbol may include or represent a function, a variable, a buffer, an object, an argument, a call, a software method, a device (e.g., a controller), or any other semantic portion of code (whether compiled or uncompiled). Determining at least one of a symbol or a 3rd-party package added or removed in the second executable code relative to the first executable code may include comparing at least a portion of the first executable code and at least a portion of the second executable code (e.g., comparing code semantics, code syntax, and/or code placement) and/or comparing at least a portion of an AST (or other representation of code) of the first executable code with at least a portion of an AST (or other representation of code) of the second executable code. As used throughout, a “3rd party” may refer to a source, creator, developer, software, or other entity that is distinct (e.g., separate from, remote from) from a particular device or system (e.g., a device or system performing any of the processes discussed herein, such as a code interpreter 102 performing one or more of processes 500, 700, 900, 1000, or 1100). For example, a 3rd-party package may include a software package that is received from an electronic source separate from a system 100 that is performing process 1000.

At step 1008, process 1000 may determine a software vulnerability associated with at least one of the at least one first element of code or the at least one second element of code. A software vulnerability may include a device security risk, a sensitive information breach risk, an operational disfunction risk, an operational misfunction risk, an operational inefficiency risk, or any other risk to expected device operation and protection. In some embodiments, determining a software vulnerability may include comparing at least one of the first element of code or the second element of code to a software vulnerability library (e.g., a list or table of verified software vulnerabilities). Additionally or alternatively, determining a software vulnerability may include analyzing the first executable code or second executable code using static or dynamic analysis.

In some embodiments, determining a software vulnerability associated with at least one of the at least one first element of code or the at least one second element of code may include determining a symbol associated with at least one of the at least one first element of code or the at least one second element of code. For example, process 1000 may identify a symbol present in or absent from at least one of the at least one first element of code or the at least one second element of code and determine that the present or absent symbol is associated with (e.g., causes, alleviates, influences) the software vulnerability.

At step 1010, process 1000 may generate a report, which may include a pairing of an indicator of the software vulnerability with an indicator of at least one of the at least one first element of code or the at least one second element of code. The report may identify a present, changed, or removed portion of code (e.g., within the first executable code or the second executable code) that is related to the presence or absence of a software vulnerability (e.g., causes the vulnerability), which may allow for more exacting deployment readiness assessment or calibration of executable code. For example, the report may identify a code delta, discussed above. A pairing may include a data structure, a data linkage, or any digital information associating the indicator of the software vulnerability with the indicator of at least one of the at least one first element of code or the at least one second element of code. In some embodiments, a different pairing may be included for the first element of code than for the second element of code. For example, the report may be generated to include a first pairing of an indicator of a first software vulnerability with an indicator of the first element of code and a second pairing of an indicator of a second software vulnerability, or an indicator of no software vulnerability, with an indicator of the second element of code. In some embodiments, the report may include multiple pairings of software vulnerability indicators with element-of-code changes between the first executable code and the second executable code. For example, differences between the first and second executable code (e.g., deltas) may be associated with respective software vulnerability indicators (including the possibility of an indicator of no software vulnerability). In some embodiments, the report may be displayable as a visual representation of the pairings and/or descriptor parameters (described further below), may be communicated or transmitted over a network, or may be otherwise accessible. Additionally or alternatively, process 1000 may update a webpage and/or transmit a notification to a client device, and the update and/or notification may include the report.

In some embodiments, the paired indicator of the software vulnerability with the indicator of at least one of the at least one first element of code or the at least one second element of code may be associated with a time and a software developer associated with introducing the software vulnerability. For example, the paired indicators may be included in a data structure that links them with the time and software developer. Additionally or alternatively, the pairings may be associated with multiple descriptor parameters. The descriptor parameters may include at least one of a file name, a build identifier, a version identifier, a commit identifier, a developer name, a date (e.g., a date of deployment, a date of installation, a date of introduction of a code delta), a time (e.g., a time of deployment, a time of installation, a time of introduction of a code delta), a symbol identifier, or a 3rd-party package identifier.

In accordance with further embodiments, the report is filterable by at least one of the descriptor parameters. For example, process 1000 may display the report visually, such as in the form of a chart or table, and may permit the visually displayed report to be adjusted to only include information (e.g., indicators) for particular elements of code, particular bodies of executable code, particular descriptor parameters (e.g., a particular version identifier, a particular developer name), including a particular range of descriptor parameters (e.g., a range of dates and/or times), or any other particular attribute differentiating different pairings. By being filterable, the report may allow for delimiting of a type of data displayed and how it is displayed (e.g., the size or layout of the visual report). In some embodiments, the report may be filterable to show software vulnerabilities related to (e.g., influenced by, caused by, removed by, introduced by) changes (e.g., deltas) between the first executable code and the second executable code.

In some embodiments, the report may be orderable by at least one of the descriptor parameters. For example, the pairings and any associated descriptor parameters may be ordered in alphabetical order, from least to greatest (or vice versa), from earliest to latest (or vice versa), or any other patterned sequence of descriptor parameters. In some embodiments, the report may include an indication of the at least one of a symbol or a 3rd-party package added or removed, as discussed above with respect to step 1006. In some embodiments, an indicator included in the report may include a determined symbol (e.g., a symbol associated with associated with at least one of the at least one first element of code or the at least one second element of code).

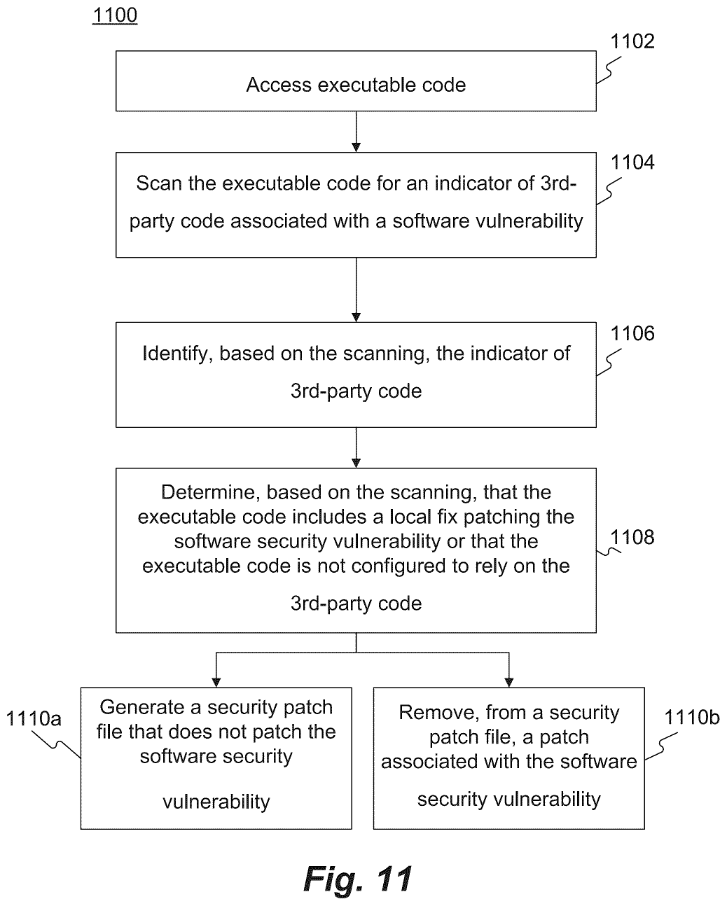

FIG. 11 shows an exemplary process 1100 for shrinking security patches. In accordance with disclosed embodiments, process 1100 may be implemented in system 100 depicted in FIG. 1, or any type of network environment. For example, process 1100 may be performed by at least one processor (e.g., processor 302), memory (e.g., memory 304), and/or other components of code interpreter 102 (e.g., components of one or more code interpreters 102), or by any computing device or IoT system. All or part of process 1100 may be implemented in conjunction with all or part of other processes discussed herein (e.g., process 500, process 700, process 900, or process 1000). For example, a device (e.g., at least one processor) may implement all or part of process 1000 to analyze build changes and associated software vulnerabilities for computer code, and may also implement all or part of process 1100 to generate or update a security patch file for the computer code.

At step 1102, process 1100 may access executable code. The executable code may include compiled and/or binary code. In some embodiments, the executable code may be configured to execute on a particular device, such as a controller. Accessing the executable code may include one or more of receiving the executable code (e.g., from a local or remote source), retrieving the executable code (e.g., retrieving from local storage, downloading from remote storage), requesting access to the executable code, compiling the executable code, or providing the executable code to a device implementing process 1100.

At step 1104, process 1100 may scan the executable code for an indicator of 3rd-party code associated with a software vulnerability. An indicator of 3rd-party code may include a combination of characters identifying the 3rd party or the 3rd-party code, a reference to the 3rd party (e.g., a call), code associated with a source separate from a primary source (e.g., developer) of the executable code, an import of at least one 3rd-party module in the source code, and/or an import of at least one 3rd-party package in the source code. For example, an indicator of 3rd-party code may include a function generated by a source separate from a primary source of the executable code (e.g., a third party). In some embodiments, the indicator of 3rd-party code may include a version identifier of the 3rd-party code (e.g., a version number, a version release date, a version implementation code, a date that 3rd-party code was added to the executable code, etc.). Scanning the executable code may include searching the executable code for at least one of a keyword, a character combination, a reference to code separate from the executable code, or a code element (e.g., function) that is not part of a known group of code elements (e.g., associated with a primary source of the executable code). Additionally or alternatively, scanning the executable code may include analyzing usage of at least one 3rd-party module in the source code and/or analyzing usage of at least one 3rd-party package in the source code. In some embodiments, process 110 may only scan portions of the executable code (e.g., designated portions, all portions except for skipped portions of the executable code identified as associated with a primary source, such as through a function name). 3rd-party code may be associated with a software vulnerability by being correlated with or known to cause the software vulnerability. In some embodiments, 3rd-party code associated with a software vulnerability may include 3rd-party code linked to an identified instance of the software vulnerability within a data structure or 3rd-party code listed on a blacklist.

In some embodiments, the 3rd-party code may be a 3rd-party software package, which may include, for example, a module, a program, or a script. A 3rd-party software package may be configured to add functionality that a device can implement by using the executable code.

At step 1106, process 1100 may identify, based on the scanning, the indicator of 3rd-party code. Identifying the indicator of 3rd-party code may include at least one of extracting the indicator of 3rd-party code, differentiating the indicator of 3rd-party code from other indicators of code, or identifying a 3rd party indicated by the indicator. In some embodiments, process 1100 may identify, based on the scanning, multiple indicators of 3rd-party code, which may be associated with the same 3rd party, or different 3rd parties.

At step 1108, process 1100 may determine, based on the scanning (or a separate scan), that the executable code includes a local fix patching the software vulnerability or that the executable code is not configured to rely on the 3rd-party code that is associated with the security vulnerability. For example, process 1100 may determine, based on searching the executable code, that the executable code includes an update, patch, fix, or other improvement, that mitigates or nullifies the security vulnerability (e.g., prevents an exploit). Making this determination may include identifying a portion of the executable code that is known to mitigate or nullify the security vulnerability, testing the executable code to determine if the security vulnerability is present, and/or analyzing functionality of the executable code to determine if the security vulnerability is present. Additionally or alternatively, process 1100 may determine that the executable code includes an update, patch, fix, or other improvement, that mitigates or nullifies the security vulnerability by analyzing source code of at least a portion of the executable code, such as by executing a search for at least one portion of irrelevant source code (e.g., source code that already exists in current source code and/or 3rd-party code that is not used in current source code). As another example, process 1100 may determine that while the executable code includes an indicator of 3rd-party code, the executable code is not configured to execute the 3rd-party code. For example, process 1100 may determine, based on the scanning, that the executable code is not configured to rely on the 3rd-party code by determining that the executable code does not include a call to (or other reference to) the 3rd-party code. In embodiments where process 1100 identifies multiple indicators of 3rd-party code associated with security vulnerabilities, process 1100 may determine that, for some of the security vulnerabilities, the executable code includes a local fix patching the software vulnerability or that the executable code is not configured to rely on the 3rd-party code that is associated with the security vulnerability, and that for others of the security vulnerabilities (i.e., for vulnerabilities still present), neither of these are true.

Based on the determination that the executable code includes a local fix patching the software vulnerability or that the executable code is not configured to rely on the 3rd-party code, process 1100 may generate a security patch file that does not patch the software vulnerability (i.e., at step 1110a) and/or remove, from a security patch file, a patch associated with the software vulnerability (i.e., at step 1110b), thereby reducing a size of the security patch file. Relying on the 3rd-party code may include referring to the 3rd-party code, being dependent on the 3rd-party code, and/or using the 3rd-party code. The security patch file may include executable code, binary code, and/or compiled code. In some embodiments, the security patch file may be configured to execute on a same device (e.g., a controller) as the executable code. In some embodiments, the security patch file may be generated to include a patch for at least one security vulnerability associated with a 3rd-party code indicator in the executable code, where process 1100 did not determine that the executable code included a local fix patching the software vulnerability or that the executable code is not configured to rely on the 3rd-party code. Thus, process 1100 can generate a security patch file that includes patches for security vulnerabilities that are substantively present in the executable code but does not include patches for security vulnerabilities that are not substantively present in the executable code (e.g., because process 1100 determined that the executable code includes a local fix patching the software vulnerability or the executable code is not configured to rely on the 3rd-party code), which can shrink the security patch file while still allowing it to include relevant remediation capabilities.

In some embodiments, process 1100 may include, in a report, an indication of the determination that the executable code includes a local fix patching the software vulnerability or that the executable code is not configured to rely on the 3rd-party code. The report may include a file, a graphic, a data structure, a chart, or any representation of the executable code and/or information associated with the executable code (e.g., vulnerability information, patch information). In some embodiments, the process 1100 may include one or more security vulnerability identifiers and one or more indicators associated with respective security vulnerability identifiers (e.g., in a chart), where each indicator may indicate whether the respective security vulnerability is addressed by a local patch included in the executable code, whether the respective security vulnerability is not relied on by the executable code, or whether the respective security vulnerability is substantively present in the executable code.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways. Unless indicated otherwise, “based on” can include one of more of being dependent upon, being derived from, being responsive to, being interdependent with, being influenced by, using information from, resulting from, or having a relationship with.

For example, while some embodiments are discussed in a context involving electronic controller units (ECUs) and vehicles, these elements need not be present in each embodiment. While vehicle communications systems are discussed in some embodiments, other electronic systems (e.g., IoT systems) having any kind of controllers may also operate within the disclosed embodiments. Such variations are fully within the scope and spirit of the described embodiments.

The disclosed embodiments may be implemented in a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and various procedural programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, or any other alternative ordering, depending upon the functionality involved. Moreover, some blocks may be executed iteratively, and some blocks may not be executed at all. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens, and authentication credentials will be developed and the scope of the these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

What is claimed is:

1. A non-transitory computer-readable medium including instructions that, when executed by at least one processor, cause the at least one processor to perform operations for analyzing software build changes, the operations comprising:
accessing first executable code associated with a first version;
accessing second executable code associated with a second version;
determining a code delta between the first executable code and the second executable code, the code delta being based on a change of at least one first element of code in the first executable code to at least one second element of code in the second executable code;
determining a software vulnerability associated with at least one of the at least one first element of code or the at least one second element of code; and
generating a report including a pairing of an indicator of the software vulnerability with an indicator of at least one of the at least one first element of code or the at least one second element of code.

2. The non-transitory computer-readable medium of claim 1, wherein the paired indicator of the software vulnerability with the indicator of at least one of the at least one first element of code or the at least one second element of code are associated with a time and a software developer associated with introducing the software vulnerability.

3. The non-transitory computer-readable medium of claim 1, wherein the report includes multiple pairings of software vulnerability indicators with element-of-code changes between the first executable code and the second executable code.

4. The non-transitory computer-readable medium of claim 3, wherein the pairings are associated with multiple descriptor parameters.

5. The non-transitory computer-readable medium of claim 4, wherein the report is filterable by at least one of the descriptor parameters.

6. The non-transitory computer-readable medium of claim 4, wherein the report is orderable by at least one of the descriptor parameters.

7. The non-transitory computer-readable medium of claim 4, wherein the descriptor parameters include at least one of a file name, a build identifier, a version identifier, a commit identifier, a developer name, a date, a time, a symbol identifier, or a 3rd-party package identifier.

8. The non-transitory computer-readable medium of claim 1, wherein:
determining a code delta between the first executable code and the second executable code comprises determining at least one of a symbol or a 3rd-party package added or removed in the second executable code relative to the first executable code; and
the report includes an indication of the at least one of a symbol or a 3rd-party package added or removed.

9. The non-transitory computer-readable medium of claim 1, wherein:
determining a software vulnerability associated with at least one of the at least one first element of code or the at least one second element of code comprises determining a symbol associated with at least one of the at least one first element of code or the at least one second element of code; and
the indicator included in the report includes the determined symbol.

10. A computer-implemented method for analyzing software build changes, comprising:
accessing first executable code associated with a first version;
accessing second executable code associated with a second version;
determining a code delta between the first executable code and the second executable code, the code delta being based on a change of at least one first element of code in the first executable code to at least one second element of code in the second executable code;
determining a software vulnerability associated with at least one of the at least one first element of code or the at least one second element of code; and
generating a report including a pairing of an indicator of the software vulnerability with an indicator of at least one of the at least one first element of code or the at least one second element of code.

11. The computer-implemented method of claim 10, wherein the paired indicator of the software vulnerability with the indicator of at least one of the at least one first element of code or the at least one second element of code are associated with a time and a software developer associated with introducing the software vulnerability.

12. The computer-implemented method of claim 10, wherein the report includes multiple pairings of software vulnerability indicators with element-of-code changes between the first executable code and the second executable code.

13. The computer-implemented method of claim 12, wherein the pairings are associated with multiple descriptor parameters.

14. The computer-implemented method of claim 13, wherein the report is filterable by at least one of the descriptor parameters.

15. The computer-implemented method of claim 13, wherein the report is orderable by at least one of the descriptor parameters.

16. The computer-implemented method of claim 13, wherein the descriptor parameters include at least one of a file name, a build identifier, a version identifier, a commit identifier, a developer name, a date, a time, a symbol identifier, or a 3rd-party package identifier.

17. The computer-implemented method of claim 10, wherein:
determining a code delta between the first executable code and the second executable code comprises determining at least one of a symbol or a 3rd-party package added or removed in the second executable code relative to the first executable code; and
the report includes an indication of the at least one of a symbol or a 3rd-party package added or removed.

18. The computer-implemented method of claim 10, wherein:
determining a software vulnerability associated with at least one of the at least one first element of code or the at least one second element of code comprises determining a symbol associated with at least one of the at least one first element of code or the at least one second element of code; and
the indicator included in the report includes the determined symbol.
